(19) United States
(12) Patent Application Publication
(10) Pub. No.: US 2002/0128406 A1
(43) Pub. Date: Sep. 12, 2002

(54) PROCESS FOR POLYMERIZING UNSATURATED POLYALKYLPIPERIDINES

(76) Inventors: CARL-ERIC MAGNUS WILEN, ESBO (FI); JAN ANDERS HARRY NASMAN, UPPSALA (SE); ALFRED STEINMANN, PRAROMAN (CH)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 09/334,081

(22) Filed: Jun. 16, 1999

(30) Foreign Application Priority Data
Jun. 19, 1998 (CH) 1323/98

(51) Int. Cl. C08F 4/44

(52) U.S. Cl. 526/160; 526/161; 526/204; 526/348.6; 526/217

(57) ABSTRACT

A process is described for polymerizing ethylenically unsaturated sterically hindered amines of the polyalkylpiperidine type (HALS) by means of metallocene catalyst, novel polymers resulting therefrom and novel unsaturated HALS. The novel monomeric or copolymeric compounds can be employed advantageously for stabilizing organic material against the damaging effect of light, oxygen and/or heat.

The invention relates to a process for preparing polymers comprising units of sterically hindered amines in the presence of metallocene catalysts, to such polymers, to novel ethylenically unsaturated sterically hindered amines of the polyalkylpiperidine type, to organic material stabilized by adding the monomers or polymers of the invention, and to the corresponding use of the novel compounds.

The stability of organic polymers to the damaging action of light, oxygen or heat is frequently improved by adding hindered amines as stabilizers. Also proposed are individual polymeric hindered amines or copolymers comprising certain units of hindered amines (HALS): (U.S. Pat. Nos. 5,541,274; 4,210,612; 4,413,096; 4,294,949; 4,499,220; 5,047,489), in which case the polymerization of the HALS monomers is initiated by adding azo compounds or peroxides as free-radical initiators, or the HALS units are attached to the polymer subsequently by reaction. The copolymerization of an unsaturated HALS with propylene in the presence of certain catalysts of the Ziegler-Natta type is described by C.-E. Wilen et al., J. Polym. Sc. (A), Polym. Chem. 30, 1163 (1992); and G. Bertolini et al., J. Polym. Sc. (A), Polym. Chem. 32, 961 (1994).

The use of some metallocene catalysts in connection with certain polymerizations is described in EP-B-94915, EP-A-611772, EP-A-611773 and by W. Kaminsky et al., J. Organomet. Chem. 497, 181 (1995). U.S. Pat. No. 5,703,149 describes the addition of a stabilizer from the class of the sterically hindered amines, for the polymerization of ethylene over a metallocene catalyst, shortly after the beginning of the polymerization reaction.

It has now been found that using metallocene catalysts it is also possible, surprisingly, to obtain polymers which contain the sterically hindered amine in bonded form and which are notable for particularly advantageous properties, especially when used as stabilizers for organic material against the damaging effects of light, oxygen and/or heat or as self-stabilized HALS-containing copolymers.

The invention therefore firstly provides a process for preparing polymers or copolymers by addition polymerization of an ethylenically unsaturated sterically hindered amine or of an ethylenically unsaturated sterically hindered amine and one or more further ethylenically unsaturated monomers, which comprises conducting the polymerization in the presence of a catalyst of the metallocene type.

Polymerization in the presence of a catalyst of the metallocene type is also referred to as insertion polymerization; it frequently involves a cationic polymerization.

The ethylenically unsaturated sterically hindered amine includes a carbon-carbon double bond (C═C) and is preferably one from the class of the 2,2,6,6-tetrasubstituted piperidines, comprising for example at least one group of the

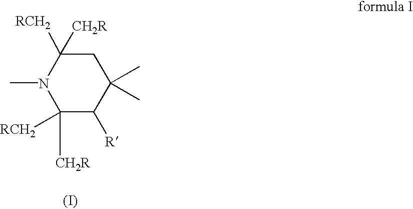

in which R and R′ are H, C₁-C₁₂alkyl or C₅-C₁₂cycloalkyl or adjacent radicals R, together with the connecting carbon atoms, form a cyclopentyl or cyclohexyl ring, and one of R and R′ can alternatively be C₂-C₁₂alkenyl or C₅-C₈cycloalkenyl- or C₆-C₉bicycloalkenyl-substituted C₁-C₈alkyl, or R′, together with one of the bonds in position 4, can form an ethylenic double bond within the ring structure, the radicals R preferably being hydrogen or methyl or C₂-C₁₂alkenyl, especially hydrogen or C₂-C₁₂alkenyl, and R′ preferably being hydrogen. If R′, together with one of the bonds in position 4, forms an ethylenic double bond within the ring structure, the ethylenically unsaturated sterically hindered amine comprises a group I′

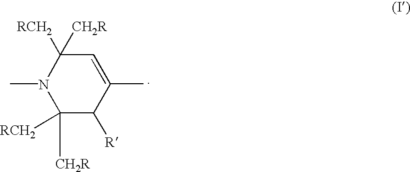

The compound involved is often of the formula Ia

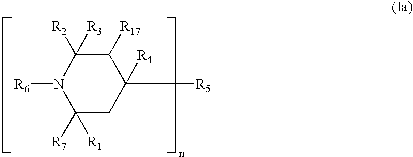

in which n is 1 or 2, especially 1;

R₁, R₂ and R₃ are C₁-C₄alkyl; or R₂ and R₃ together are C₄-C₁₁alkylene;

R₄ and R₁₇ are hydrogen or R₄ together with R₁₇ is a chemical bond and R₅, if n=1, is hydrogen, OH, C₁-C₁₈alkyl, C₇-C₁₅phenylalkyl, C₃-C₁₂alkenyl, C₅-C₁₂cycloalkyl, cyclohexenyl, acryloyloxy, acryloylamido, phenylene- or cyclohexylene-interrupted C₁-C₁₈alkyl or C₃-C₁₂alkenyl, or is a radical of the formula —X—(CO)ᵢ—R₈ or of the formula —O—Si(R₁₈)(R₁₉)(R₂₀) or, if R₁₇ is hydrogen, R₄ and R₅ together are ═O; the index i being 0 or 1;

and R₅, if n=2, is a radical of the formula —X—CO—R₁₀—CO—X;

R₆ is hydrogen, C₁-C₁₈alkyl, C₃-C₈alkenyl, C₇-C₁₁phenylalkyl, or C₇-C₁₁phenylalkyl substituted on the phenyl ring by C₁-C₁₂alkyl and/or OH;

R₇ is C₃-C₁₂alkenyl or C₁-C₄alkyl; or R₇ together with R₁ is C₄-C₁₁alkylene;

R₈ is C₁-C₁₈alkyl, C₃-C₁₂alkenyl, C₇-C₁₅phenylalkyl, C₈-C₁₅phenylalkenyl, C₇-C₁₅phenylalkyl substituted in the phenyl moiety by C₁-C₄alkyl or C₂-C₄alkenyl or C₁-C₄alkoxy, or is phenyl or C₁-C₄alkyl- or C₂-C₄alkenyl- or C₁-C₄alkoxy-substituted phenyl;

R₉ is C₁-C₁₂alkyl or C₅-C₁₂cycloalkyl;

R₁₀ is a direct bond, C₁-C₁₂alkylene or C₂-C₁₂alkenylene, or phenyl- or naphthyl-substituted C₂-C₁₂alkenylene;

R₁₈ and R₁₉ independently of one another are C₁-C₈alkyl, especially methyl;

R₂₀ is a hydrocarbon radical containing 1 to 18 carbon atoms;

X is —NH—, —NR₉— or —O—; with the proviso that the compound of the formula Ia comprises an ethylenical double bond.

Preference is given to a compound of the formula Ib

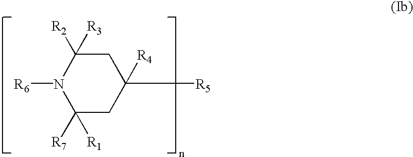

in which n is 1 or 2, especially 1;

R₁, R₂ and R₃ are C₁-C₄alkyl; or R₂ and R₃ together are C₄-C₁₁alkylene;

R₄ is hydrogen and R₅, if n=1, is hydrogen, C₃-C₁₂alkenyl, C₅-C₈cycloalkenyl- or C₆-C₉-bicycloalkenyl-substituted C₁-C₈alkyl, acryloyloxy, acryloylamido, or is a radical of the formula —X—(CO)ᵢ—R₈, or R₄ and R₅ together are ═O; the index i being 0 or 1;

and R₅, if n=2, is a radical of the formula —X—(CO)ⱼ—R₁₀—(CO)ⱼ—X, the index j being 0 or 1, especially 0;

R₆ is hydrogen, C₁-C₁₈alkyl, C₃-C₁₂alkenyl, or phenyl-, C₅-C₈cycloalkenyl- or C₆-C₉bicycloalkenyl-substituted C₁-C₈alkyl;

R₇ is C₃-C₁₂alkenyl or C₁-C₄alkyl, or C₅-C₈cycloalkenyl- or C₆-C₉bicycloalkenyl-substituted C₁-C₈alkyl; or R₇ together with R₁ is C₄-C₁₁alkylene;

R₈ is C₁-C₁₈alkyl, C₃-C₁₂alkenyl, C₇-C₁₅phenylalkyl, C₈-C₁₅phenylalkenyl, or C₇-C₁₅phenylalkyl substituted in the phenyl moiety by C₁-C₄alkyl or C₁-C₄alkoxy, or phenyl, or C₁-C₄alkyl- or C₁-C₄alkoxy-substituted phenyl; or is cyclohexenyl; or is C₁-C₈alkyl substituted by C₅-C₈cycloalkenyl or C₆-C₉bicycloalkenyl;

R₉ is C₁-C₁₂alkyl or C₅-C₁₂cycloalkyl;

R₁₀ is a direct bond, C₁-C₁₂alkylene or C₂-C₁₂alkenylene or is phenyl- or naphthyl-substituted C₂-C₁₂alkenylene; or is —X—R₈-substituted 1,3,5-triazinediyl;

X is —NH—, —NR₉— or —O—;

with the proviso that the compound of the formula Ib comprises an ethylenical double bond.

Particular preference is given to those compounds of the formula Ia or Ib

in which n is 1 or 2, especially 1;

R₁R₂ and R₃ are C₁-C₄alkyl; or R₂ and R₃ together are C₄-C₁₁alkylene;

R₄ is hydrogen and R₅, if n=1, is hydrogen, C₃-C₁₂alkenyl or a radical of the formula —X—(CO)ᵢ—R₈, or R₄ and R₅ together are ═O; the index i being 0 or 1;

and R₅, if n=2, is a radical of the formula —X—CO—R₁₀—CO—X;

R₆ is hydrogen, C₁-C₁₈alkyl, C₃-C₁₂alkenyl;

R₇ is C₃-C₁₂alkenyl or C₁-C₄alkyl; or R₇ together with R₁ is C₄-C₁₁alkylene;

R₈ is C₁-C₁₈alkyl, C₃-C₁₂alkenyl, C₇-C₁₅phenylalkyl, C₈-C₁₅phenylalkenyl, or C₇-C₁₅phenylalkyl substituted in the phenyl moiety by C₁-C₄alkyl or C₁-C₄alkoxy, or is phenyl or C₁-C₄alkyl- or C₁-C₄alkoxy-substituted phenyl;

R₉ is C₁-C₁₂alkyl or C₅-C₁₂cycloalkyl;

R₁₀ is a direct bond, C₁-C₁₂alkylene or C₂-C₁₂alkenylene or is phenyl- or naphthyl-substituted C₂-C₁₂alkenylene;

X is —NH—, —NR₉— or —O—;

with the proviso that the compound of the formula Ia or Ib comprises an ethylenically unsaturated group.

In preferred compounds of the formula Ia, R₅, if n=1, is C₃-C₁₂alkenyl or a radical of the formula —X—(CO)ᵢ—R₈, the index i being 0 or 1, or R₄ and R₅ together are ═O. X is preferably —NH— or —NR₉—.

An ethylenically unsaturated group is to be understood as meaning one having a nonaromatic carbon-carbon double bond. The sterically hindered amine preferably contains an ethylenical double bond in form of an ethylenically unsaturated group attached to, but not part of, the piperidine ring. The sterically hindered amine more preferably comprises the ethylenically unsaturated group, e.g. vinyl group, in a terminal position, especially bonded in a distance of 2 or more carbon atoms from the piperidine nitrogen atom. Most preferably, the sterically hindered amine contains only one single ethylenically unsaturated group.

Also preferred is an unsaturated sterically hindered amine, which comprises no further hetero atom except for the active nitrogen atom, e.g. the nitrogen within the piperidine ring.

In preferred compounds of the formula Ia or Ib, n is 1 if R₆ or R₇ or, if present, R′₇ forms the ethylenically unsaturated group and is 1 or 2 if R₅ comprises the ethylenically unsaturated group.

Aromatic radicals, or aryl, in the context of the stated definitions, are preferably phenyl, naphthyl or more highly fused ring systems, which can also be substituted by, for example, from 1 to 3 halogens, C₁-C₄alkyls or C₁-C₄alkoxys.

A hydrocarbon radical R₂₀ is for example C₁-C₁₈alkyl, C₃-C₁₈alkenyl, C₇-C₁₅phenylalkyl, C₇-C₁₈cycloalkylalkyl, C₇-C₁₈cycloalkenylalkyl, C₇-C₁₈bicycloalkylalkyl or C₇-C₁₈bicycloalkenylalkyl.

The further ethylenically unsaturated monomer to be employed in accordance with the invention is preferably of the formula II

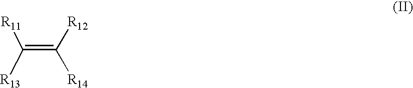

in which

R₁₁, R₁₂ and R₁₃ independently of one another are hydrogen; —CI; C₁-C₁₈alkyl; phenyl; phenyl substituted from 1 to 3 times by —CI, C₁-C₄alkyl and/or C₁-C₄alkoxy; or are C₇-C₉phenylalkyl; and

R₁₄ is as defined for R₁₁, R₁₂ or R₁₃ or is —CN; C₁-C₁₂alkyloxycarbonyl; C₁-C₁₂alkanoyloxy; or C₁-C₁₂alkoxy.

Where present, comonomers of the formula 11 in the product obtained in accordance with the invention often form a molar fraction of 0-99 mol %, for example 0-50 mol %, of the repeating units; comonomers of the formula 11 are conveniently incorporated in an amount from 0 to 99.9% by weight of the (co)polymer. Of particular importance for use as stabilizer are homopolymers, which are obtained without the addition of comonomers of the formula II.

Of particular technical importance are copolymers; preference is given to those in which the fraction of the comonomers of the formula 11 is 10-99.9% by weight, preferably 50-99.9 or 60-99.8% by weight, especially 80-99.5% by weight, and, in particular, 90-99% by weight. The amount of active nitrogen (of the sterically hindered amine) in the most preferred (co)polymers usually is between 0.01 and 1%, especially 0.02-0.4%, by weight of the (co)polymer.

The structural units with the formula I and II depicted above and below are ethylenically unsaturated monomers. The constituent repeating units of the resultant polymer are derived from the monomer units by the replacement of the ethylenic double bond by two open bonds which make the constituent repeating unit part of a polymer chain. Copolymers can be, for example, random, alternating or block copolymers.

The metallocene catalysts to be employed in accordance with the invention are, for example, compounds of the formula A

{[(R₂₁)(R₂₂M)ₐ]^{an+}an/q[LQₘ]^{q-}} (A),

in which a is 1 or 2 and n and q independently of one another are each an integer from 1 to 4, M is the cation of a monovalent to tetravalent metal from group IVb to VIIb, VII or Ib of the Periodic Table of the Elements, m is an integer corresponding to the valency of L+q, Q is a halogen atom, L is a divalent to heptavalent metal or nonmetal, R₂₁ is a π-arene and R₂₂ is a π-arene or the anion of a π-arene. Particularly suitable π-arenes R₂, and R₂₂ are aromatic groups having 6 to 24 carbon atoms or heteroaromatic groups having 3 to 30 carbon atoms, it being possible for these groups to be unsubstituted or substituted one or more times by identical or different monovalent radicals such as halogen atoms, preferably chlorine or bromine atoms, or by C₁-C₈alkyl, C₁-C₈alkoxy, cyano, C₁-C₈alkylthio, C₂-C₆monocarboxylic acid alkyl ester, phenyl, C₂-C₅alkanoyl or benzoyl groups. These π-arene groups can be monocyclic, condensed polycyclic or uncondensed polycyclic systems, it being possible for the rings in the latter systems to be attached directly or via bridges such as —S— or —O—. R₂₂ as the anion of a π-arene can be an anion of a π-arene of the abovementioned type, for example the indenyl anion and especially the cyclopentadienyl anion, it also being possible for these anions to be unsubstituted or substituted one or more times by identical or different monovalent radicals such as C₁-C₈alkyl, C₂-C₆monocarboxylic acid alkyl ester, cyano, C₂-C₅alkanoyl or benzoyl groups.

The alkyl, alkoxy, alkylthio, monocarboxylic acid alkyl ester and alkanoyl substituents here can be straight-chain or branched. As typical alkyl, alkoxy, alkylthio, monocarboxylic acid alkyl ester and alkanoyl substituents mention may be made respectively of methyl, ethyl, n-propyl, isopropyl, n-butyl, sec-butyl, tert-butyl, n-pentyl, n-hexyl and n-octyl, methoxy, ethoxy, n-propoxy, isopropoxy, n-butoxy, n-hexyloxy and n-octyloxy, methylthio, ethylthic, n-propylthio, isopropylthio, n-butylthio, n-pentylthio and n-hexylthio, carboxylic acid methyl, ethyl, n-propyl, isopropyl, -n-butyl and n-pentyl ester, and acetyl, propionyl, butyryl and valeroyl. Of these, preference is given to alkyl, alkoxy, alkylthio and monocarboxsylic acid alkyl ester groups having 1 to 4 and especially 1 or 2 carbon atoms in the alkyl moieties and also alkanoyl groups having 2 or 3 carbon atoms. As substituted π-arenes or anions of substituted π-arenes preference is given to those containing one or two of the abovementioned substituents, especially chlorine or bromine atoms, methyl, ethyl, methoxy, ethoxy, cyano, carboxylic acid methyl or ethyl ester groups and acetyl groups.

Identical or different π-arenes may be present as R₂₁ and R₂₂. Suitable heteroaromatic π-arenes are S—, N— and/or O-containing systems. Heteroaromatic π-arenes containing S and/or O atoms are preferred.

Examples of suitable π-arenes are benzene, toluene, xylene, ethylbenzene, methoxybenzene, ethoxybenzene, dimethoxybenzene, p-chlorotoluene, chlorobenzene, bromobenzene, dichlorobenzene, acetylbenzene, trimethylbenzene, trimethoxybenzene, naphthalene, 1,2-dihydronaphthalene, 1,2,3,4-tetrahydronaphthalene, methyinaphthalenes, methoxynaphthalenes, ethoxynaphthalenes, chloronaphthalenes, bromonaphthalenes, biphenyl, indene, biphenylene, fluorene, phenanthrene, anthracene, 9,10-dihydroanthracene, triphenylene, pyrene, naphthacene, coronene, thiophene, chromene, xanthene, thioxanthene, benzothiophene, naphthothiophene, thianthrene, diphenylene oxide, diphenyl sulfide, acridine and carbazole.

If a is 2, each R₂₂ is preferably the anion of a π-arene and M is in each case the same metal atom.

Examples of anions of substituted π-arenes are the anions of methyl-, ethyl-, n-propyl- and n-butylcyclopentadiene, and the anions of dimethylcyclopentadiene, of cyclopentadienecarboxylic acid methyl and ethyl esters, and of acetylcyclopentadliene, propionylcyclopentadiene, cyanocyclopentadiene and benzoylcyclopentadiene. Preferred anions are the anion of unsubstituted indene, and especially of unsubstituted cyclopentadiene.

Preferably, a is 1 and R₂₂ is benzene, toluene, xylene, methoxybenzene, chlorobenzene, p-chlorotoluene, naphthalene, methylnaphthalene, chloronaphthalene, methoxynaphthalene, biphenyl, indene, pyrene or diphenylene sulfide, and R₂₂ is the anion of cyclopentadiene, acetylcyclopentadiene or indene or is benzene, toluene, xylene, trimethylbenzene, naphthalene or methylnaphthalene.

Particular preference is given to those complexes of the formula (A) in which a is 1, R₂₁ is η⁶-pyrene or η⁶-naphthalene and R₂₂ is the anion of η⁵-cyclopentadiene, n is preferably 1 or 2, especially 1, and q is preferably 1. M is, for example, Ti²⁺, Ti³⁺, Ti⁴⁺, Zr⁺, Zr²⁺, Zr³⁺, Zr⁴⁺, Hf⁺, Hf²⁺, Hf³⁺, Hf⁴⁺, Nb⁺, Nb²⁺, Nb³⁺, Cr⁺, Mo⁺, Mo²⁺, W⁺, W²⁺, Mn⁺, Mn²⁺, Re⁺, Fe²⁺, Co²⁺, Co³⁺, Ni²⁺ or Cu²⁺. M is preferably a titanium, zirconium or hafnium cation, especially a titanium or zirconium cation, and, with particular preference, is Ti⁴⁺ or Zr⁴⁺.

Likewise suitable as catalysts are semimetallocenes, e.g. monocyclopentadienyl derivatives in which only one cyclopentadienyl ligand is attached to a transition metal centre.

Examples of suitable metals and nonmetals L are Sb, Fe, Sn, Bi, Al, Ga, In, Ti, Zr, Sc, V, Cr, Mn and Cu; lanthanides such as Ce, Pr and Nd, or actinides such as Th, Pa, U or Np. Suitable nonmetals are, in particular, B, P and As. L is preferably P, As, B or Sb, particular preference being given to P.

Complex anions [LQₘ]^{q-} are for example BF₄⁻, PF₆⁻, AsF₆⁻, SbF₆⁻, FeCl₄⁻, SnCl₆⁻, SbCl₆⁻, and BiCl₆⁻. The particularly preferred complex anions are SbF₆⁻, BF₄⁻, AsF₆ and PF₆⁻.

In the process of the invention it is also possible to use a metallocene catalyst consisting of two principal components (A-1 and A-2).

Component A-1 in this case is a metallocene compound. It is possible in principle to employ any metallocene irrespective of its structure and composition. The metallocenes can be either bridged or unbridged and have identical or different ligands. They are compounds of the metals of groups IVb, Vb or VIb of the Periodic Table, examples being compounds of titanium, zirconium, hafnium, vanadium, niobium, tantalum, chromium, molybdenum, tungsten, preferably of zirconium, hafnium and titanium, and especially of zirconium.

Such metallocenes are known and are described, for example, in the following documents: EP-A-0 336 127; EP-A-0 336 128; EP-A-0 387 690; EP-A-0 387 691; EP-A-0 302 424; EP-A-0 129 368; EP-A-0 320 762; EP-A-0 284 707; EP-A-0 316 155; EP-A-0 351 392; U.S. Pat. No. 5,017,714; J. Organomet. Chem., 342 (1988) 21; Polymeric Materials Encyclopedia, Ed. J. C. Salamone, CRC Press, 1997; EP-A-0 781 783.

Particular mention should be made of metallocenes of the general structure

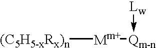

in which

M^{m+} is an m-valent cation of a metal of groups IVb, Vb or VIb of the Periodic Table, for example titanium, zirconium, hafnium, vanadium, niobium, tantalum, chromium, molybdenum, tungsten, preferably zirconium, hafnium and titanium, especially zirconium;

(C₅H₅₋ₓRₓ) is a cyclopentadienyl ring which is substituted by from zero to five substituents R;

x is a number zero, one, two, three, four or five;

n is one or two;

R, independently at each occurrence, is a C₁-C₂₀hydrocarbon radical, a C₁-C₂₀hydrocarbon radical substituted by one or more halogen atoms, a metalloid-substituted C₁-C₂₀hydrocarbon radical, or halogen; or two adjacent radicals R are a C₄-C₂₀ ring; or, if n is 1, R is a radical B_{y}-JR′_{z-1-y}, in which

J is an element from group VA of the Periodic Table having the coordination number 3 or an element from group VIA of the Periodic Table having the coordination number 2, preferably N, P, O or S;

R′, independently at each occurrence, is a C₁-C₂₀hydrocarbon radical or is a

C₁-C₂₀hydrocarbon radical substituted by one or more halogen atoms;

z is the coordination number of the element J;

y is zero or one;

B, if y is one, is a bridge comprising an element of group IVA or VA of the Periodic Table, for example C₁-C₂₀alkylene, a di-C₁-C₂₀alkyl-, C₇-C₂₀alkylaryl- or di-C₆-C₂₀aryl-silicon or -germanium radical, or an alkyl- or aryl-phosphine or amine radical;

or R, if n is two, is a group selected from —M₂(R₁₀)(R₁₁)—, —M₂(R₁₀)(R₁₁)—M₂(R₁₀)(R₁₁)—, —C(R₁₀)(R₁₁)—C(R₁₀)(R₁₁)—, —O—M₂(R₁₀)(R₁₁)—O—, —C(R₁₀)(R₁₁)—, —O—M₂(R₁₀)(R₁₁)—, —C(R₁₀)(R₁₁)—M₂(R₁₀)(R₁₁)—, —B(R₁₀)—, —Al(R₁₀)—, —Ge—, —Sn—, —O—, —S—, —S(O)—, —S(O)₂—, —N(R₁₀)—, —C(O)—, —P(R₁₀)— or —P(O)(R₁₀)—;

where

R₁₀ and R₁₁ are identical or different and are a hydrogen atom, a halogen atom, a. C₁-C₁₀alkyl group, a C₁-C₁₀fluoroalkyl group, a C₆-C₁₀aryl group, a C₆-C₁₀fluoroaryl group, a C₁-C₁₀alkoxy group, a C₂-C₁₀alkenyl group, a C₇-C₄₀arylalkyl group, a C₈-C₄₀arylalkenyl group, or a C₇-C₄₀alkylaryl group, or R₁₀ and R₁₁, in each case with the atoms connecting them, form a ring, and

M₂ is silicon, germanium or tin,

Q, independently at each occurrence, is hydrogen, a C₁-C₅₀hydrocarbon radical, a C₁-C₅₀hydrocarbon radical substituted by one or more electron-withdrawing groups, for example halogen or alkoxy, or is a metalloid-substituted C₁-C₅₀hydrocarbon radical, the metalloid being an element of group IVA of the Periodic Table, with the exception of hydrocarbon radicals of the formula (C₅H₅₋ₓRₓ); or two radicals Q are alkylidene, olefin, acetylene or a cyclometallated hydrocarbon radical;

L is a neutral Lewis base, for example diethyl ether, tetrahydrofuran, dimethylaniline, aniline, trimethylphosphine or n-butylamine; and

w is a number from 0 to 3.

Metalloid is to be understood as meaning, for example, the elements silicon, germanium, tin and lead.

A preferred type of metallocene corresponds in this case to the following structure:

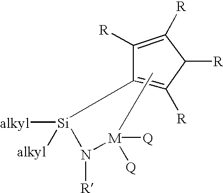

in which M is Ti or Zr and the other substituents are as indicated above.

Further details of metallocenes of the above type can be found in WO 92/00333.

For the isospecific polymerization of substituted olefin comonomers of the formula II, e.g. propene, butene, styrene, and their copolymerization, with each other and with other olefins, there is interest in metallocenes, especially zirconocenes, which carry indenyl derivatives as ligands. The compounds concerned are preferably of the formula C below

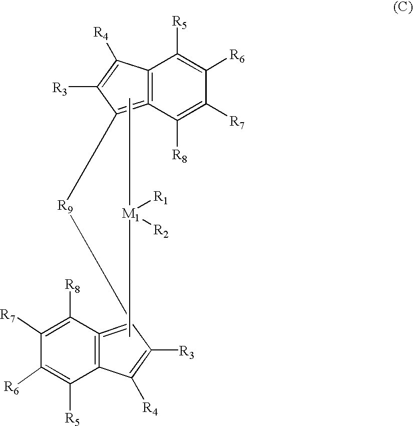

in which

M₁ is a metal of group IVb, Vb or VIb of the Periodic Table;

R₁ and R₂ are identical or different and are a hydrogen atom, a C₁-C₁₀alkyl group, a C₁-C₁₀alkoxy group, a C₆-C₁₀aryl group, a C₆-C₁₀aryloxy group, a C₂-C₁₀alkenyl group, a C₇-C₄₀arylalkyl group, a C₇-C₄₀alkylaryl group, a C₈-C₄₀arylalkenyl group, an OH group or a halogen atom,

the radicals R₃ are identical or different and are a hydrogen atom, a halogen atom, a C₁-C₁₀alkyl group which can be halogenated, a C₆-C₁₀aryl group, an —NR₂, —SR, —OSiR₃, —SiR₃ or PR₂ radical, in which R is a halogen atom, a C₁-C₁₀alkyl group or a C₆-C₁₀aryl group;

R₄ to R₈ are as defined for R₃, or adjacent radicals R₄ to R₈, with the atoms connecting them, form an aromatic or aliphatic ring,

R₉ is a group selected from —M₂(R₁₀)(R₁₁)—, —M₂(R₁₀)(R₁₁)—M₂(R₁₀)(R₁₁)—, —C(R₁₀)(R₁₁)—C(R₁₀)(R₁₁)—, —O—M₂(R₁₀)(R₁₁)—O—, —C(R₁₀)(R₁₁)—, —O—M₂(R₁₀)(R₁₁)—, —C(R₁₀)(R₁₁)—M₂(R₁₀)(R₁₁)—, —B(R₁₀)—, —Al(R₁₀)—, —Ge—, —Sn—, —O—, —S—, —S(O)—, —S(O)₂—, —N(R₁₀)—, —C(O)—, —P(R₁₀)— or —P(O)(R₁₀)—; where

R₁₀ and R₁₁ are identical or different and are a hydrogen atom, a halogen atom, a C₁-C₁₀alkyl group, C₁-C₁₀fluoroalkyl group, a C₆-C₁₀aryl group, a C₆-C₁₀fluoroaryl group, a C₁-C₁₀alkoxy group, a C₂-C₁₀alkenyl group, a C₇-C₄₀arylalkyl group, a C₈-C₄₀arylalkenyl group, a C₇-C₄₀alkylaryl group, or R₁₀ and R₁₁, each with the atoms connecting them, form a ring, and M₂ is silicon, germanium or tin.

Likewise of importance are the 4,5,6,7-tetrahydroindenyl analogues corresponding to the compounds of the formula (C).

Preferably in formula (C)

M₁ is zirconium,

R₁ and R₂ are identical and are methyl or chlorine, especially chlorine,

R₃ to R₈ are hydrogen or C₁-C₄alkyl,

R₉ is —Si(R₁₀)(R₁₁)—, —C(R₁₀)(R₁₁)— or —C(R₁₀)(R₁₁)—C(R₁₀)(R₁₁)—, and

R₁₀ and R₁₁ are identical or different and are C₁-C₄alkyl or C₆-C₁₀aryl. In particular, R₁₀ and R₁₁, are identical or different and are methyl or phenyl.

The indenyl or tetrahydroindenyl ligands in formula (C) are substituted preferably in positions 2, 2,4, 4,7, 2,6, 2,4,6, 2,5,6, 2,4,5,6 and 2,4,5,6,7, especially in positions 2,4,6. Substitution is preferably by a C₁-C₄alkyl group such as methyl, ethyl or isopropyl. The 2 position is preferably substituted by methyl.

Also of particular importance are compounds of the formula (C) in which the substituents in positions 4 and 5 of the indenyl radicals (R₅ and R₆), together with the atoms connecting them, form a benzene ring. This condensed ring system can likewise be substituted by radicals having the definition of R₃-R₈. An example of such compounds is dimethylsilanediylbis(2-methyl-4,5-benzoindenyl)zirconium dichloride.

The metallocenes of the formula (C) are particularly suitable for preparing high molecular mass polyolefins having high stereoregularity.

Of particular importance as well are compounds of the formula (C) with (subst.) phenyl, naphthyl substituted in position 4.

For the syndiospecific polymerization of substituted olefin comonomers of the formula II, e.g. propene, butene and styrene, and their copolymerization, with each other and with other olefins, there is also interest in metallocenes of the formula (D):

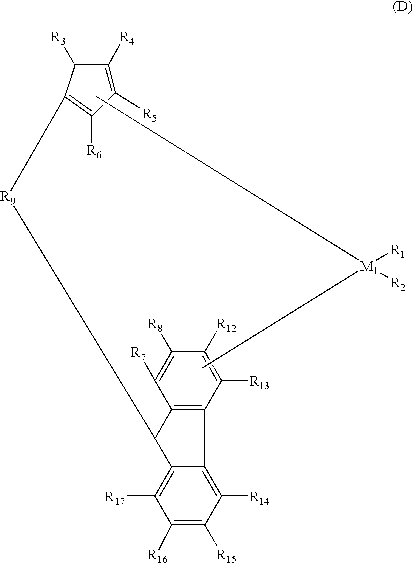

in which

M₁ is a metal of group IVb, Vb or VIb of the Periodic Table;

R₁ and R₂ are identical or different and are a hydrogen atom, a C₁-C₁₀alkyl group, a C₁-C₁₀alkoxy group, a C₆-C₁₀aryl group, a C₆-C₁₀aryloxy group, a C₂-C₁₀alkenyl group, a C₇-C₄₀arylalkyl group, a C₇-C₄₀alkylaryl group, a C₈-C₄₀arylalkenyl group, an OH group or a halogen atom,

the radicals R₃ are identical or different and are a hydrogen atom, a halogen atom, a C₁-C₁₀alkyl group which can be halogenated, a C₆-C₁₀aryl group, an —NR₂, —SR, —OSiR₃, —SiR₃ or PR₂ radical, in which R is a halogen atom, a C₁-C₁₀alkyl group or a C₆-C₁₀aryl group;

R₄ to R₈ are as defined for R₃, or adjacent radicals R₄ to R₈, with the atoms connecting them, form an aromatic or aliphatic ring,

R₉ is a group selected from —M₂(R₁₀)(R₁₁)—, —M₂(R₁₀)(R₁₁)—M₂(R₁₀)(R₁₁)—, —C(R₁₀)(R₁₁)—C(R₁₀)(R₁₁)—, —O—M₂(R₁₀)(R₁₁)—O—, —C(R₁₀)(R₁₁)—, —O—M₂(R₁₀)(R₁₁)—, —C(R₁₀)(R₁₁)—M₂(R₁₀)(R₁₁)—, —B(R₁₀)—, —Al(R₁₀)—, —Ge—, —Sn—, —O—, —S—, —S(O)—, —S(O)₂—, —N(R₁₀)—, —C(O)—, —P(R₁₀)— or —P(O)(R₁₀)—; where

R₁₀ and R₁₁ are identical or different and are a hydrogen atom, a halogen atom, a C₁-C₁₀alkyl group, C₁-C₁₀fluoroalkyl group, a C₆-C₁₀aryl group, a C₆-C₁₀fluoroaryl group, a C₁-C₁₀alkoxy group, a C₂-C₁₀alkenyl group, a C₇-C₄₀arylalkyl group, a C₈-C₄₀arylalkenyl group, a C₇-C₄₀alkylaryl group or R₁₀ and R₁₁, in each case with the atoms connecting them, form a ring, and

M₂ is silicon, germanium or tin; and

R₁₂ to R₁₇ are as defined for R₃.

Examples of metallocenes which can be used in accordance with the invention include the following compounds:

biscyclopentadienylzirconium dichloride, biscyclopentadienylzirconium dimethyl, biscyclopentadienylzirconium diphenyl, biscyclopentadienylzirconium dibenzyl, biscyclopentadienylzirconium bistrimethylsilyl, bis(methylcyclopentadienyl)zirconium dichloride, bis(1,2-dimethylcyclopentadienyl)zirconium dichloride, bis(1,3-dimethylcyclopentadienyl)zirconium dichloride, bis(1,2,4-trimethylcyclopentadienyl)zirconium dichloride, bis(1,2,3-trimethylcyclopentadienyl)zirconium dichloride, bis(pentamethylcyclopentadienyl)zirconium dichloride, bisindenylzirconium dichloride, bis(tetrahydroindenyl)zirconium dichloride, dimethylsilylbis-1-tetrahydroindenylzirconium dichloride, dimethylsilylbis-1-(2-methyltetrahydroindenyl)zirconium dichloride, dimethylsilylbis-1-(2,3,5-trimethylcyclopentadienyl)zirconium dichloride, dimethylsilylbis-1-(2,4-dimethylcyclopentadienyl)zirconium dichloride, dimethylsilylbis-1-indenylzirconium dichloride, dimethylsilylbis-1-indenylzirconium dimethyl, dimethylgermylbis-1-indenylzirconium dichloride, dimethylsilylbis-1-(2-methylindenyl)zirconium dichloride, dimethylsilylbis-1-(2-methyl-4-isopropylindenyl)zirconium dichloride, phenylmethylsilylbis-1-(2-methylindenyl)zirconium dichloride, dimethylsilylbis-1-(2-methyl-4-ethylindenyl)zirconium dichloride, ethylenebis-1-(4,7-dimethylindenyl)zirconium dichloride, phenyl(methyl)silylbis-1-indenylzirconium dichloride, phenyl(vinyl)silylbis-1-indenylzirconium dichloride, diphenylsilylbis-1-indenylzirconium dichloride, dimethylsilylbis(1-(2-methyl-4-tert-butylindenyl))zirconium dichloride, methylphenylsilylbis(1-(2-methyl-4-isopropylindenyl))zirconium dichloride, dimethylsilylbis(1-(2-ethyl-4-methylindenyl))zirconium dichloride, dimethylsilylbis(1-(2,4-dimethylindenyl))zirconium dichloride, dimethylsilylbis(1-(2-methyl-4-ethylindenyl))zirconium dichloride, dimethylsilylbis(2-methyl-4,6-diisopropylindenyl)zirconium dichloride, dimethylsilylbis(2,4,6-trimethylindenyl)zirconium dichloride, methylphenylsilylbis(2-methyl-4,6-diisopropylindenyl)zirconium dichloride, 1,2-ethanediylbis(2-methyl-4,6-diisopropylindenyl)zirconium dichloride, dimethylsilyl-(9-fluorenyl)(cyclopentadienyl)zirconium dichloride, diphenylsilyl(9-fluorenyl)(cyclopentadienyl)zirconium dichloride, diphenylmethylene(9-fluorenyl)cyclopentadienylzirconium dichloride, isopropylidene(9-fluorenyl)cyclopentadienylzirconium dichloride, phenylmethylmethylene(9-fluorenyl)cyclopentadienylzirconium dichloride, isopropylidene(9-fluorenyl)(1-(3-isopropyl)cyclopentadienyl)zirconium dichloride, isopropylidene(9-fluorenyl)(1-(3-methyl)cyclopentadienyl)zirconium dichloride, diphenylmethylene(9-fluorenyl)(1-(3-methyl)cyclo-pentadienyl)zirconium dichloride, methylphenylmethylene(9-fluorenyl)(1-(3-methyl)cyclopentadienyl)zirconium dichloride, dimethylsilyl(9-fluorenyl)(1-(3-methyl)-cyclopentadienyl)zirconium dichloride, diphenylsilyl(9-fluorenyl)(1-(3-methyl)-cyclopentadienyl)zirconium dichloride, diphenylmethylene(9-fluorenyl)(1-(3-tert-butyl)cyclopentadienyl)zirconium dichloride and isopropylidene(9-fluorenyl)(1-(3-tert-butyl)cyclopentadienyl)zirconium dichloride.

For the preparation of the catalyst, chiral metallocenes are employed preferably in racemate form. Alternatively, the pure R or S form can be used. With these pure stereoisomeric forms it is possible to prepare optically active polymer. However, the meso form of the metallocenes should be isolated, since the polymerization-active centre (the metal atom) in these compounds is no longer chiral, owing to mirror symmetry at the central metal, and is therefore unable to produce highly tactic polymer. If the meso form is not isolated, then atactic polymer is formed alongside isotactic and/or syndiotactic polymers. For certain applications—soft mouldings, for example—or for the preparation of polyethylene grades, this may in fact be desirable. The stereoisomers are separated in accordance with methods known from the literature.

Component A-2 suitably comprises, for example, the following compounds:

a) Aluminoxanes

The aluminoxane used is preferably a compound of the formula (III)

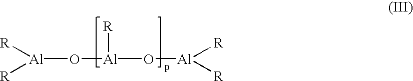

for the linear type and/or of the formula (IV)

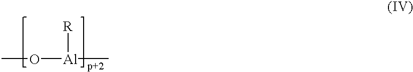

for the cyclic type, the radicals R in the formulae (III) and (IV) being identical of different and being a C₁-C₆alkyl group, a C₆-C₁₈aryl group, benzyl or hydrogen, and p is an integer from 2 to 50, preferably from 10 to 35.

Preferably, radicals R are identical and are methyl, isobutyl, n-butyl, phenyl or benzyl, especially methyl.

If the radicals R are different, they are preferably methyl and hydrogen, methyl and isobutyl or methyl and n-butyl, in which case preferably 0.01-40% of the radicals R present are hydrogen and/or isobutyl or n-butyl.

The aluminoxane can be prepared in various ways by known methods. One of the methods, for example, is to react an aluminium hydrocarbon compound and/or a hydridoaluminium hydrocarbon compound with water (gaseous, solid, liquid or bound—as water of crystallization, for example) in an inert solvent (for example, toluene). To prepare an aluminoxane having different alkyl groups R, two different aluminium trialkyls (AIR₃+AIR′₃) in accordance with the desired composition and reactivity are reacted with water (cf. S. Pasynkiewicz, Polyhedron 9 (1990) 429 and EP-A-302 424).

The precise structure of the aluminoxanes of the formula (III) and (IV) is unknown.

Irrespective of the nature of their preparation, a common feature of all aluminoxane solutions is a varying content of unreacted aluminium starting compound which is present in free form or as adduct.

b) Ion Exchange Compounds

Ion exchange compounds are compounds containing a cation which reacts irreversibly with a ligand of component A-1 and a non-coordinating anion which is sterically bulky, labile and chemically inert. Combining the components A-1 and A-2 produces an ion couple comprising the cation of A-2 and a ligand of A-1. Examples of cations of component A-2 are Bronsted acids, such as ammonium ions, or reducible Lewis acids, such as Ag⁺ or ferrocene ions.

The aluminoxane which can be used as component A-2 can also be formed in the preparation of a supported catalyst from trimethylaluminium.

In addition to homogeneous catalyst systems, the metallocenes can also be used as heterogeneous catalysts. In this case, the catalyst is applied to an organic or inorganic support by methods known to the skilled worker from the literature. The inorganic support materials are preferably silica gels; further details in this regard can be found, for example, in U.S. Pat. No. 5,240,894.

Examples of organic support materials are microporous polymeric supports, which are obtainable commercially (e.g. the ®Accurel grades from AKZO, such as ®Accurel-PE, ®Accurel-PP, ®Accurel-PA-6 or ®Accurel-PA-12 with a voids content of about 75% by volume). The pore size of the ®Accurel materials is 0.5-5 μm (PP), 1.0-5 μm (HDFPE), 0.5-3 μm (PA-6 and PA-12).

Advantageously, the microporous polymeric support is dried beforehand, for example by treatment with aluminium alkyl solutions, and then washed and rendered inert under an inert gas.

The preferred procedure for this is first to react the aluminoxane with at least one metallocene by intensive mixing—by stirring, for example—in a suitable solvent, examples being pentane, hexane, heptane, toluene and dichloromethane. The reaction temperature is preferably from −20 to +120° C., especially 15-40° C. The molar ratio of aluminium to transition metal M of the metallocene is preferably from 10:1 to 10,000:1, in particular from −100:1 to 2000:1. The reaction time is generally from 5 to 120 minutes, preferably 10-30 minutes. It is preferred to operate with an aluminium concentration of more than 0.01 mol/l, in particular more than 0.5 mol/l. The reaction is conducted under inert conditions.

Instead of the aluminoxane it is also possible to use a mixture of aluminoxane with another aluminium alkyl compound, such as trimethyl-, triethyl- or triisobutylaluminium, for the described reaction with the metallocene.

After reaction has taken place, the solvent can be partially removed in vacuo, for example, or, following concentration, can be replaced by another solvent. The solution prepared in this way is reacted appropriately with the microporous polymeric support. In this case the support is added at least in an amount whose total pore volume is able to accommodate the solution from the preceding reaction. This reaction takes place preferably at temperatures from −20 to +20° C., in particular 15-40° C., by intensive mixing—for example, by stirring or treatment with ultrasound. Homogenization should be thorough. In this case, the exchange of this inert gas of the pore volume can be accelerated, for example, by brief evacuation.

In principle, the preparation of the supported catalyst can also be carried out in a one-pot reaction: in other words, all 3 starting components are reacted with one another simultaneously in a suitable solvent/suspension medium. In this case the amount of the polymeric support should preferably be such that it is able to accommodate the total liquid volume.

The catalyst can be metered into the polymerization system as a suspension in an inert suspension medium such as heptane, n-decane, hexane or diesel oil, for example, or else in dry form, possibly after removal of the residual solvent by a drying step in vacuo, For example.

The catalyst can advantageously be prepolymerized in the gas phase, in the liquid monomer or in suspension, in which case it is possible to do without the addition of a further organoaluminium compound.

The polymerization with these catalysts can be carried out by known methods in liquid or gaseous phase. The liquid phase can, for example, be an aliphatic hydrocarbon or the liquid monomer itself. The metallocene catalysts can also be employed in a mixture with other catalyst types, such as Ziegler or Phillips catalysts. At the end of the polymerization the catalyst is destroyed by, for example, adding water (steam), wet nitrogen, carbon dioxide or alcohol.

The preparation of the metallocene catalyst systems is known and is described, for example, in the publication EP-A-755948 and literature cited therein.

Particular preference is given to the catalysts (1,1′-dimethylsilanylenebis(η⁵-4,5,5,7-tetrahydro-1-indenyl))zirconium dichloride/methylalumoxane; rac-(CH₃)₂Si(IndH₄)₂ZrCl₂/methylaluminoxane; rac-(CH₃)2Si(lnd)₂ZrCl₂/methylaluminoxane; rac-(1,4-butanediyl)₂Si(lndH₄) ₂ZrCl₂/methylaluminoxane; rac-C₂H₅(2-(t-butyidimethylsilyloxy)lnd)₂ZrCl₂/methylaluminoxane; (CH₃) ₂C(fluorenyl)(cyclopentadienyl)ZrCl₂/methylaluminoxane; rac-(CH₃)₂Si(lnd)ZrCl₂/triphenylmethyltetrakis(pentafluorophenyl)borane.

The polymers obtained in accordance with the invention have outstanding properties, as set out below in more detail. The invention therefore also provides a polymer or copolymer as obtainable by the process of the invention.

The polymer of the invention frequently has a molecular weight (Mₙ; measured by means of gel permeation chromatography) in the range 1000-2 000 000, especially 2000-1 000 000, in particular 5000-500 000, and a particularly narrow -molecular weight distribution. Homopolymers formed from structural units of the formula I often have a molecular weight Mₙ of from 1000 to 30 000 g/mol, in particular from 1000 to 10 000 g/mol; the copolymers mentioned, comprising units of the formula II, preferably have a molecular weight Mn in the range from 10 000 to 1 000 000 g/mol.

In accordance with the process of the invention (depending on the symmetry of the metal centre) it is possible to carry out specific preparation of isotactic, syndiotactic or atactic copolymers, in analogy to the known use of the metallocene catalysts in the preparation of polyolefins.

Some of the unsaturated sterically hindered amines employed preferably as starting materials in accordance with the process of the invention are novel compounds. The invention therefore further provides compounds of the formula V, VI, VII or VIII

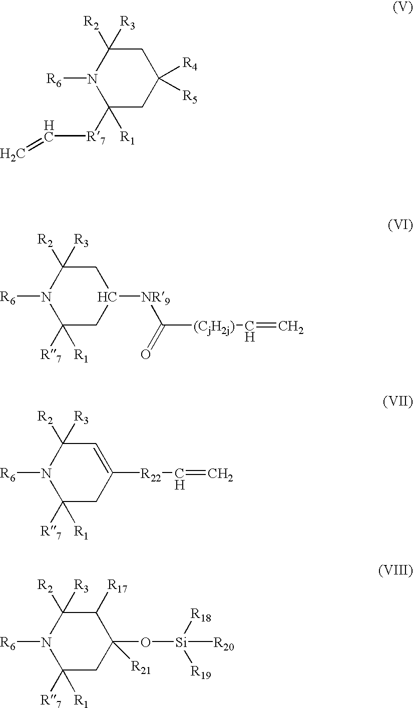

in which R₁, R₂ and R₃ are C₁-C₄alkyl; or R₂ and R₃ together are C₄-C₁₁alkylene;

R₄ is hydrogen;

R₅ is hydrogen, OH, C₁-C₁₈alkyl, C₃-C₁₂alkenyl, acryloyloxy, acryloylamido, or is a radical of the formula —X—(CO)ᵢ—R₈, where i is 0 or 1; or R₄ and R₅ together are ═O;

R₆ is hydrogen, C₁-C₁₈alkyl, C₃-C₈alkenyl, C₇-C₁₁phenylalkyl, or C₇-C₁₁phenylalkyl substituted on the phenyl ring by C₁-C₁₂alkyl and/or OH;

the index j is a number from the range 1-12, especially 4-12;

R′₇ is C₁-C₈alkylene;

R″₇ is C₁-C₄alkyl; or R″₇ together with R₁ is C₄-C₁₁alkylene;

R₈ is C₁-C₁₈alkyl, C₃-C₁₂alkenyl, C₇-C₁₅phenylalkyl, C₈-C₁₅phenylalkenyl, C₇-C₁₅phenylalkyl substituted in the phenyl moiety by C₁-C₄alkyl or C₁-C₄alkoxy, or is phenyl or C₁-C₄alkyl- or C₁-C₄alkoxy-substituted phenyl;

R₉ is C₁-C₁₂alkyl or C₅-C₁₂cycloalkyl;

R′₉ is hydrogen, C₁-C₁₂alkyl or C₅-C₁₂cycloalkyl;

R₁₈ and R₁₉ independently of one another are C₁-C₈alkyl, especially methyl;

R₂₀ is C₃-C₁₈alkenyl, C₇-C₁₈cycloalkenylalkyl or C₇-C₁₈bicycloalkenylalkyl;

R₁₇ and R₂, are hydrogen, or R₁₇ together with R₂₁ is a chemical bond;

R₂₂ is C₂-C₁₆alkylene, phenylene, phenylene- or cyclohexylene-interrupted C₂-C₁₀alkylene, or alkylene-phenylene of a total of 2-16 carbon atoms; especially straight-chain C₂-C₁₆alkylene;

X is —NH—, —NR₉— or —O—.

With particular preference, R₁, R₂, R₃ and R″₇ are hydrogen.

Of these compounds, preference is given to compounds of the formula V or VI,

in which R₁-R₆ are as defined earlier above for the formula Ia;

the index j is a number from the range 1-12, especially 4-12;

R′₇ is C₁-C₈alkylene;

R″₇ is C₁-C₄alkyl; or R″₇ together with R₁ is C₄-C₁₁alkylene;

R′₉ is hydrogen, C₁-C₁₂alkyl or C₅-C₁₂cycloalkyl.

In the compounds V-VII, R₁-R₆ preferably have the following definitions:

R₁, R₂ and R₃ are C₁-C₄alkyl; or R₂ and R₃ together are C₄-C₁₁alkylene;

R₄ is hydrogen; and R₅ is hydrogen or —X—(CO)ᵢ—R₈, the index i being 0 or 1;

R₆ is hydrogen, C₁-C₁₈alkyl, or phenyl-substituted C₁-C₈alkyl; where

R₈ is C₁-C₁₈alkyl, C₇-C₁₅phenylalkyl, C₇-C₁₅phenylalkyl substituted in the phenyl moiety by C₁-C₄alkyl or C₁-C₄alkoxy, or is phenyl or C₁-C₄alkyl- or C₁-C₄alkoxy-substituted phenyl;

R₉ is C₁-C₁₂alkyl or C₅-C₁₂cycloalkyl; and

X is —NH—, —NR₉— or —O—.

The unit (C^{j}H₂ⱼ) in the formula VI is preferably straight-chain corresponding to the formula (CH₂)^{j}.

Particular preference is given to compounds of the formula V, especially those of the formula Va

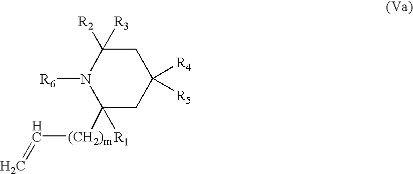

in which m is a number from the range 1-8;

R₁ is methyl or ethyl;

R₂ and R₃ are as defined for R₁ or together are C₄-C₁₁alkylene;

R₄ is hydrogen and

R₅ is hydrogen or a radical of the formula —X—(CO)ᵢ—R₈; the index i being 0 or 1;

or R₄ and R₅ together are ═O;

R₆ is hydrogen or C₁-C₁₈alkyl;

R₈ is C₁-C₁₈alkyl, C₇-C₁₅phenylalkyl, C₇-C₁₅phenylalkyl substituted in the phenyl moiety by C₁-C₄alkyl or C₁-C₄alkoxy, or is phenyl or C₁-C₄alkyl- or C₁-C₄alkoxy-substituted phenyl;

R₉ is C₁-C₁₂alkyl or C₅-C₁₂cycloalkyl; and

X is —NH—, —NR₉— or —O—.

The novel compounds of the formula V are advantageously prepared by reacting a suitable saturated ketone, for example diacetoneamine, with a preferably terminally unsaturated ketone, for example 3-buten-2-one, 4-penten-2-one, 5-hexen-2-one, 6-hepten-2-one, 7-octen-2-one, 8-nonen-2-one or 9-decen-2-one, with or without the addition of solvent.

The reaction can otherwise be carried out in analogy to known preparation methods for sterically hindered amines; temperature, work-up and any subsequent reactions, such as hydrogenation, esterification, amidation, etc., can be carried out in analogy to known reactions.

Compounds of the formula VI are judiciously obtained by condensing a compound of the formula X

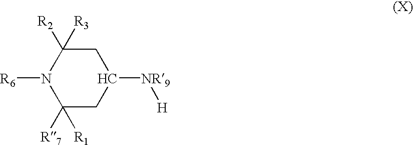

with a suitable unsaturated acid or acid derivative, for example of the formula X′—CO—(CⱼH₂ⱼ)—CH═CH₂, in which the index j is as defined above for formula VI and X is H or halogen, especially H or Cl. The reaction can be carried out in a manner known per se, for example in the presence of solvents and/or catalysts; also possible is a condensation without such additives, using for example the acid and removing the condensation product by heating. Examples of solvents which can be used include hydrocarbons and chlorinated hydrocarbons; examples of catalysts include, for example, bases, among which are tertiary amines.

Compounds of the formula VII are judiciously obtained in analogy to known methods, for example by addition of unsaturated halogens or Grignard compounds of the type X′—R₂₂—CH═CH₂ onto the desired 4-oxopiperidine compound with subsequent elimination of water.

Compounds of the formula VIII are judiciously obtained in analogy to known methods, for example by reacting suitably substituted monochlorosilanes with the desired 4-oxopiperidine compound or 4-hydroxypiperidine compound.

Work-up can, if desired, be carried out by the conventional methods: for example, by distillation, chromatography, crystallization or recrystallization from the solution.

Other compounds of the formulae Ia and Ib are known in the majority of cases or can be prepared in analogy to known compounds.

The polymers and copolymers obtained in accordance with the process of the invention, especially those containing 10-100 mol %, for example 50-100 mol %, but especially 5-10% by weight, of units of the sterically hindered amine type, and also the novel compounds of the formulae V-VIII, especially V and VI, are particularly suitable for use as stabilizers for organic material against its damage by light, oxygen and/or heat. Monomers of the formulae V-VIII, especially V and VI, are able, furthermore, to bind reactively to the substrate into which they are incorporated. The polymeric or monomeric compounds of the invention feature high substrate compatibility and good persistency in the substrate.

Examples of materials to be stabilized in accordance with the invention are:

1. Polymers of monoolefins and diolefins, for example polypropylene, polyisobutylene, polybut-1-ene, poly-4-methylpent-1-ene, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:

a) radical polymerisation (normally under high pressure and at elevated temperature).

b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either Tc- or c-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (I-LDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

5. Polystyrene, poly(p-methylstyrene), poly(α-methylstyrene).

6. Copolymers of styrene or α-methylstyrene with dienes or acrylic derivatives, for example styrene/butadiene, styrene/acrylonitrile, styrene/alkyl methacrylate, styrene/bultadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/ styrene.

7. Graft copolymers of styrene or x-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, oolybutylene terephthalate, poly-1,4-dimethylolcyclohexane terephthalate and polyhydroxybenzoates, as well as block copolyether esters derived from hydroxyl-terminated polyethers; and also polyesters modified with polycarbonates or MBS.

19. Polycarbonates and polyester carbonates.

20. Polysulfones, polyether sulfones and polyether ketones.

21. Crosslinked polymers derived from aldehydes on the one hand and phenols, ureas and melamines on the other hand, such as phenol/formaldehyde resins, urea/formaldehyde resins and melamine/formaldehyde resins.

22. Drying and non-drying alkyd resins.

23. Unsaturated polyester resins derived from copolyesters of saturated and unsaturated dicarboxylic acids with polyhydric alcohols and vinyl compounds as crosslinking agents, and also halogen-containing modifications thereof of low flammability.

24. Crosslinkable acrylic resins derived from substituted acrylates, for example epoxy acrylates, urethane acrylates or polyester acrylates.

25. Alkyd resins, polyester resins and acrylate resins crosslinked with melamine resins, urea resins, isocyanates, isocyanurates, polyisocyanates or epoxy resins.

26. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

27. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

28. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

The invention therefore further provides compositions comprising

A) an organic material sensitive to oxidative, thermal and/or actinic degradation and

B) at least one polymer or copolymer obtainable in accordance with the process of the invention and/or a compound of the formula V, VI, VII and/or VIII, and provides for the use of the novel polymeric and/or monomeric compounds for stabilizing organic material against oxidative, thermal or actinic degradation. The invention likewise embraces a method of stabilizing organic material against thermal, oxidative and/or actinic degradation, which comprises adding to this material at least one polymer or copolymer obtainable in accordance with the process of the invention and/or a compound of the formula V, VI, VII and/or VIII.

Of particular interest is the use of the novel polymeric and/or monomeric compounds as stabilizers in synthetic organic polymers, especially thermoplastic polymers, and corresponding compositions.

The organic materials to be protected are preferably natural, semisynthetic or, preferably, synthetic organic materials. Particular preference is given to synthetic organic polymers or mixtures of such polymers, especially thermoplastic polymers such as polyolefins or styrene copolymers, examples being those listed above under 1., 2., 3., 6. and 7., such as polyethylene, polypropylene or styrene and copolymers, especially polyethylene (PE) and polypropylene (PP).

In general, the novel polymeric and/or monomeric compounds are added in amounts of from 0.01 to 50%, preferably from 0.05 to 20% and, in particular, from 0.05 to 10% to the material that is to be stabilized (amounts based on the weight of the material to be stabilized). Particular preference is given to the use of the compounds of the invention in amounts in which the HALS monomer or comonomer is present in amounts of from 0.05 to 1.5%, in particular from 0.1 to 0.5%.

Incorporation into the materials can take place, for example, by mixing in or applying the stabilizers of the invention, with or without further additives, by the methods customary in the art. Where polymers are concerned, especially synthetic polymers, incorporation can take place prior to or during the shaping operation, or by applying the dissolved or dispersed compound to the polymer, with or without subsequent evaporation of the solvent. In the case of elastomers, these can also be stabilized as lattices. A further possibility for incorporation of the stabilizers of the invention into polymers is to add them before, during or directly after the polymerization of the corresponding monomers and/or prior to crosslinking. In this case the novel polymeric or monomeric compounds can be added per se or else in encapsulated form (in waxes, oils or polymers, for example).

The stabilizers of the invention can also be added in the form of a masterbatch which comprises the compound(s), for example, in a concentration of from 2.5 to 25% by weight, to the polymers that are to be stabilized.

The stabilizers of the invention can judiciously be incorporated by the following methods:

as an emulsion or dispersion (e.g. to lattices or emulsion polymers),

as a dry mix during the mixing of additive components or polymer mixtures,

by direct addition to the processing apparatus (e.g. extruders, internal mixers, etc.), or

as a solution or melt.

With particular advantage, the stabilizer of the invention is added to a thermoplastic polymer prior to its processing at elevated temperature, as is often performed, for example, by means of an extruder.

Polymer compositions of the invention can be employed in various forms and/or processed to various products, for example as (or to) films, fibres, tapes, moulding compounds, profiles, or as binders for coating materials, adhesives or putties.

In addition to the stabilizers of the invention, the compositions of the invention may include, as additional component C, one or more conventional additives, such as those indicated below, for example.

The conventional additives are judiciously employed in amounts of 0.01-10, for example 0.01-3% by weight, based on the material to be stabilized.

1. Antioxidants

1.1. Alkylated monolphenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-((x-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis-(3,5-di-tert-butyl-4-hydroxyphenyl) adipate.

1.4. Tocopherols, for example α-tocopherol, γ-tocopherol, γ-tocopherol, δ-tocopherol and mixtures thereof (Vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(x-methycyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl) -4-nonylphenol], 2,2′-methylenebis[6-(α,α-dimethylbenzyl)-4-nonylphenol], 4,4′-methylenebis (2,6-di-tert-butylphenol), 4,4′-methylenebis(6-tert-butyl-2-methylphenol), 1,1-bis(5-tert-butyl -4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy -2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy -3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis-(3,5-di-tert-butyl-2-hydroxybenzyl)-malonate, di-octadecyl-2-(3-tert-butyl-4-hydroxy-5-methylbenzyl)-malonate, di-dodecylmercaptoethyl -2,2-bis-(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris-(3,5-di-tert-butyl-4-hydroxybenzyl) -2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine Compounds, for example 2,4-bis(octylmercapto)-6-(3,5-di-tert-butyl-4-hydroxyanilino) -1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro -1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylplhosphonate, the calcium salt of the monoethyl ester of 3,5-di-tert-butyl-4-hydroxybenzylphosphionic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of D-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.15. Esters of β(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl -1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl -1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl -4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)-hydrazide, N,N′-bis[2-(3-[3,5-di-tert-butyl-4-hydroxyphenyl]propionyloxy)ethyl]oxamide (Naugard®XL-1 supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2- naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenlenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyidiphenylamine, 4-n-butylamino-phenol, 4-butyrylaminophenol, 4-nonanoylaminophenol, 4-dodecanoylaminophebnol, 4-octa-decanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl -4,4′-diaminodiphenylmethane, 1,2-bis[(2-methylphenyl)amino]ethane, 1,2-bis(phenylamino)-propane, (o-tolyl)biguanide, bis[4-(1′,3′-dimethylbutyl)phenyl]amine, tert-octylated N-phenyl -1-naphthylamine, a mixture of mono- and dialkylated tert-butyl/tert-octyldipheriylamines, a mixture of mono- and dialkylated nonyldiphenylamines, a mixture of mono- und dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-di-methyl -4H-1,4-benzothiazine, phenothiazine, a mixture of mono- und dialkylated tert-butyl/-tert-octylphenothiazines, a mixture of mono- und dialkylated tert-octyl-phenothiazines, N-allylphenothiazin, N,N,N′,N′-tetraphenyl-1,4-diaminobut-2-ene, N,N-bis(2,2,6,6-tetramethyl-piperid -4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

2. UV Absorbers and Light Stabilisers

2.1.2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl -2′-hydroxyphenyl)-5-chloro-benzotriazole, 2-(3′-tert-butyl-2′-hydroxy-5′-methylphenyl) -5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy -5′-(2-octyloxycarbonylethyl)phenyl)-5-chloro-benzotriazole, 2-(3′-tert-butyl-5′-[2-(2-ethylhexyl-oxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)-benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl -2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl -5′-(2-methoxycarbonylethyl)-2′-hydroxyphenyl]-2H-benzotriazole with polyethylene glycol 300; [R—CH₂CH₂—COO—CH₂CH₂] where R=3′-tert-butyl-4′-hydroxy-5′-2H-benzotriazol -2-ylphenyl, 2-[2′-hydroxy-3′-(α,α-dimethylbenzyl)-5′-(1,1,3,3-tetramethylbutyl)-phenyl]-benzotriazole; 2-[2′-hydroxy-3′-(1,1,3,3-tetramethylbutyl)-5′-(α,α-dimethylbenzyl)-phenyl]benzotriazole.

2.2.2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, as for example 4-tertbutyl-phenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxy-cinnamate, butyl α-cyano-β-methyl-p-methoxy-cinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thio-bis-[4-(1,1,3,3-tetramethylbutyl)phenol], such as the 1:1 or 1:2 complex, with or without additional ligands, such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenyl undecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl) -2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-di-chloro -1,3,5-triazine, tris(2,2,6,6-tetramethyl-4-piperidyl)nitrilotriacetate, tetrakis(2,2,6,6-tetramethyl -4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decan-2,4-dione, bis(1l-octyloxy -2,2,6,6-tetramethylpiperidyl)sebacate, bis(1-octyloxy-2,2,6,6-tetramethylpiperidyl)succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino -2,2,6,6-tetramethylpiperidyl)-1,3,5-triazine and 1,2-bis(3-aminopropylamino)-ethane, the condensate of 2-chloro-4,6-di-(4-n-butylamino-1,2,2,6,6-pentamethylpiperidyl) -1,3,5-triazine and 1,2-bis-(3-aminopropylamino)ethane, 8-acetyl-3-dodecyl-7,7,9,9-tetramethyl -1,3,8-triazaspiro[4.5]decane-2,4-dione, 3-dodecyl-1-(2,2,6,6-tetramethyl-4-piperidyl)pyrrolidin -2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino -2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl -1-oxa-3,8-diaza-4-oxospiro [4,5]decane und epichlorohydrin, 1,1-bis(1,2,2,6,6-pentamethyl -4-piperidyloxycarbonyl)-2-(4-methoxyphenyl)ethene, N,N′-bis-formyl-N,N′-bis(2,2,6,6-tetramethyl -4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl -4-piperidyl)]siloxane, reaction product of maleic acid anhydride-(x-olefin-copolymer with 2,2,6,6-tetramethyl-4-aminopiperidine or 1,2,2,6,6-pentamethyl-4-aminopiperidine.

2.7. Oxamides, for example 4,4′-dioctyloxyoxanilide, 2,2′-diethoxyoxanilide, 2,2′-dioctyloxy -5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl) -1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyl-oxyphenyl) -6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl) -1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propoxy)phenyl]-4,6-bis(2,4-dimethyl)-1,3,5-triazine, 2-[2-hydroxy-4-(2-hydroxy-3-octyloxy-propyloxy)phenyl]-4,6-bis(2,4-dimethyl)1,3,5-triazine, 2-[4-(dodecyloxy/tridecyloxy-2-hydroxypropoxy)-2-hydroxy-phenyl]-4,6-bis(2,4-dimethylphenyl) -1,3,5-triazine, 2-[2-hydroxy-4-(2-hydroxy-3-dodecyloxy-propoxy)phenyl]-4,6-bis(2,4-dimethylphenyl) -1,3,5-triazine, 2-(2-hydroxy-4-hexyloxy)phenyl-4,6-diphenyl-1,3,5-triazine, 2-(2-hydroxy -4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl -1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

3. Metal Deactivators, for example N,N′-diphenyloxamide, N-salicylal-N′-salicyloyl hydrazine, N,N′-bis(salicyloyl) hydrazine, N,N′-bis(3,5-di-tert-butyl-4-hydroxyphenylpropionyl) hydrazine, 3-salicyloylamino-1,2,4-triazole, bis(benzylidene)oxalyl dihydrazide, oxianilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl -4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butyl-phenyl)pentaerythritol diphosphite, tristearyl sorbitol triphosphite, tetrakis(2,4-di-tert-butyl-phenyl) 4,4′-biphenylene diphosphonite, 6-isooctyloxy-2,4,8,10-tetra-tert-butyl-12H-dibenz-[d,g]-1,3,2-dioxaphosphocin, bis(2,4-di-tert-butyl-6-methylphenyl) methyl phosphite, bis(2,4-di-tert-butyl-6-methylphenyl) ethyl phosphite, 6-fluoro-2,4,8,10-tetra-tert-butyl-12-methyl-di-benz[d,g]-1,3,2-dioxaphosphocin, 2,2′,2″-nitrilo[triethyltris(3,3′,5,5′-tetra-tert-butyl-1,1′-biphenyl -2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

Especially preferred are the following phosphites:

Tris(2,4-di-tert-butylphenyl) phosphite (Irgafos®168, Ciba-Geigy), tris(nonylphenyl) phosphite,

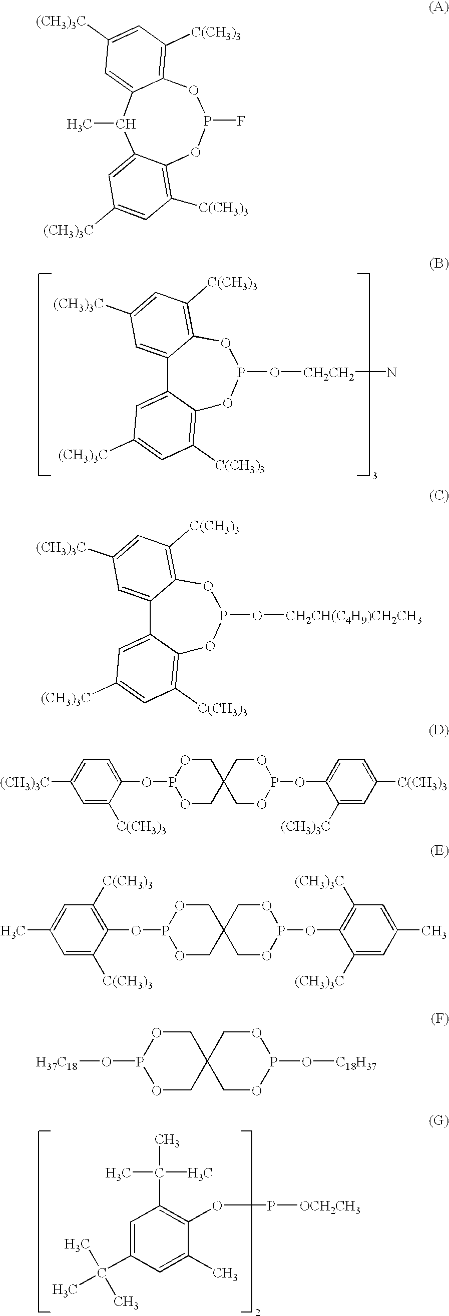

5. Hydroxylamines, for example, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenyl-nitrone, N-ethyl-alpha-methyl-nitrone, N-octyl-alpha-heptyl-nitrone, N-lauryl-alpha-undecyl-nitrone, N-tetradecyl-alpha-tridcyl-nitrone, N-hexadecyl-alpha-pentadecyl-nitrone, N-octadecyl-alpha-heptadecyl-nitrone, N-hexadecyl-alpha-heptadecyl-nitrone, N-ocatadecyl-alpha-pentadecyl-nitrone, N-heptadecyl-alpha-heptadecyl-nitrone, N-octadecyl-alpha-hexadecyl-nitrone, nitrone derived from N,N-dialkylhydroxylamine derived from hydrogenated tallow amine.

7. Thiosynergists, for example, dilauryl thiodipropionate or distearyl thiodipropionate.

8. Peroxide scavengers, for example esters of, -thiodipropionic acid, for example the lauryl, stearyl, myristyl or tridecyl esters, mercaptobenzimidazole or the zinc salt of, 2-mercaptobenzimidazole, zinc dibutyldithiocarbamate, dioctadecyl disulfide, pentaerythritol tetrakis(β-dodecylmercapto)propionate.

9. Polyamide stabilisers, for example, copper salts in combination with iodides and/or phosphorus compounds and salts of divalent manganese.

10. Basic co-stabilisers, for example, melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids for example calcium stearate, zinc stearate, magnesium behenate, magnesium stearate, sodium ricinoleate and potassium palmitate, antimony pyrocatecholate or zink pyrocatecholate.

11. Nucleating agents, for example, inorganic substances such as talcum, metal oxides such as titanium dioxide or magnesium oxide, phosphates, carbonates or sulfates of, preferably, alkaline earth metals; organic compounds such as mono- or polycarboxylic acids and the salts thereof, e.g. 4-tert-butylbenzoic acid, adipic acid, diphenylacetic acid, sodium succinate or sodium benzoate; polymeric compounds such as ionic copolymers (ionomers). Especially preferred are 1,3:2,4-bis(3′,4′-dimethylbenzylidene)sorbitol, 1,3:2,4-di(paramethyldibenzylidene)sorbitol, und 1,3:2,4-di(benzylidene)sorbitol.

12. Fillers and reinforcing agents, for example, calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

13. Other additives, for example, plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839 or EP-A-0591102 or 3-[4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran -2-one, 3-(3,5-dimethyl-4-pivaloyloxyphenyl)-5,7-di-tert-butylbenzofuran -2-one, 3-(3,4-dimethylphenyl)-5,7-di-tert-butyl-benzofuran-2-one, 3-(2,3-dimethylphenyl)-5,7-di-tert-butyl-benzofuran-2-one.

The examples which follow illustrate the invention further. All parts and percentages in the examples as in the remainder of the description and claims are by weight unless stated otherwise.

The following abbreviations are used in the examples:

GC: Gas chromatography;

HPLC High-pressure liquid chromatography;

GPC: Gel permeation chromatography;

THF: Tetrahydrofuran;

MALDI: Matrix Assisted Laser Desorption Ionization;

MS: Mass spectrometry;

DSC: Differential thermal analysis;

MAO: Methylalumoxane (manufacturer: Witco);

Mₙ: Number average molar mass (units: g/mol);

M_{w}: Mass average molar mass (units: g/mol);

H-NMR: Nuclear magnetic resonance of the nuclide ¹H.

1 torr (=1 mmHg) corresponds to a pressure of approximately 133 Pa.

A) Preparation of the Monomers (HALS)

Al) Preparation of 2-(but-3-enyl)-2,6,6-trimethyl-4-oxopiperidine

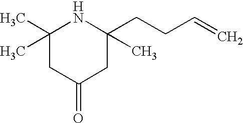

a) 31 g (0.27 mol) of diacetoneamine, 52.8 g (0.54 mol) of 5-hexen-2-one and 17 g (0.15 mol) of calcium chloride are heated to 59° C. in a 500 ml round-bottom flask with thermometer and reflux condenser. After 5 days, the viscose reaction mixture is discharged into a mixture of sodium hydroxide solution and dichioromethane. The organic phase is separated off and dried over sodium sulfate and filtered and the filtrate is concentrated on a rotary evaporator. The residue is distilled in vacuo (boiling point: 90° C./2 torr). The yield is 5 g (10%) of 2-(but-3-enyl)-2,6,6-trimethyl-4-oxopiperidine.

H-NMR: 1.19 (s, br, CH3, 3H), 1.24 (s, br, CH3, 3H), 1.24 (s, br, CH3, 3H), 1.4-1.6 (m, CH2—C═C, 2H), 1.9 (m, CH2—C—C═C, 2H), 2.1-2.3 (m, CH2—CO, 4H), 4.9-5.1 (m, CH2═, 2H), 5.7-5.9 (m, CH═C, 1 H).

MS: M+(0), 180 (16), 140 (100), 123 (11), 98 (20), 83 (79), 58 (32), 42 (76).

A1b) Alternatively, anhydrous ammonia (30 g, 1.76 mol) is introduced in four portions over a period of four days to a well stirred mixture of powdered anhydrous calcium chloride (75 g, 0.67 mol), 5-hexen-2-one (125 g, 1.28 mol) and diacetonalcohol (150 g, 1.28 mol) at −47° C. Then, the homogeneous mixture is heated to 59-° C. and stirred for additionally four days. The reaction mixture is poured into 500 ml of an aqueous solution containing 100 g sodium hydroxide. The oil is decanted and the remaining caustic slurry washed with dichloromethane. The compained oil and dichloromethane extracts are dried over anhydrous sodium sulfite. The drying agent is removed by filtration and the filtrate is concentrated on a rotating evaporator. Then, the apparatus is converted for distillation, and the reaction mixture is stirred at 40° C. under reduced pressure (5 mmHg). The remaining solution weights 45 g and consists essentially of a 1:1 mixture of triacetonamine and 2-(but-3-enyl)-2,6,6-trimethyl-4-oxo-piperidine. The title product is isolated by distillation (2 mmHg).

A2) Preparation of 2-(but-3-enyl)-2,6,6-trimethylpiperidine

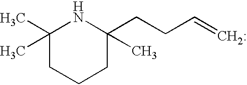

5 g (0.026 mol) of 2-(but-3-enyl)-2,6,6-trimethyl-4-oxopiperidine (product from Example A1), 4.7 g (0.086 mol) of potassium hydroxide, 6 g (0.19 mol) of hydrazine hydrate and 18.2 g of diethylene glycol are heated at 130° C. for 2 hours and then boiled over a water separator at 195° C. The organic phase is distilled (80° C., 10 torr). The yield is 2 g (43%).

H-NMR: 1.08 (s, CH3, 3H), 1.1 (s, CH3, 3H), 1.13 (s, CH3, 3H), 1.35 (m, CH2, 6H), 1.5-1.7 (m, CH2, 2H), 2.0-2.1 (m, CH2-C═C, 2H), 4.9-5.1 (m, CH2═, 2H), 5.7-5.9 (m, CH═, 1H).

MS: 181 (5), 166 (26), 138 (2), 126 (100), 110 (12), 81 (6), 70 (44), 41 (32).

A3) Preparation of

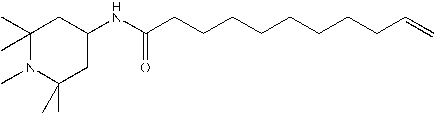

In a 100 ml round-bottom flask with magnetic stirrer and top-mounted distillation unit, 34.0 g (0.2 mol) of 1,2,2,6,6-pentamethyl-4-aminopiperidine and 36.8 g (0.2 mol) of 10-undecenoic acid are heated to 180° C. with stirring. Following a reaction period of 7 h and removal of the water by distillation, the mixture is cooled to room temperature. Subsequent distillation at 0.03 torr and 200° C. gives the title product.

A4) Preparation of

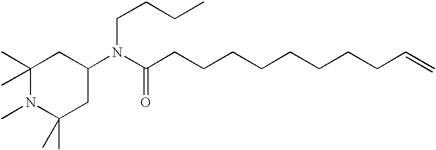

22.6 g of 1,2,2,6,6-pentamethyl-4-butylaminopiperidine and 11.1 g of triethylamine are dissolved in 150 ml of methylene chloride. The solution is cooled to 0° C. using ice/NaCl. 20.3 g of (10)-undecenoyl chloride, as a solution in 50 ml of methylene chloride, are added dropwise over 20 minutes. The ice bath is removed and the solution is stirred at room temperature for 1 h, then washed twice with 50 ml of H₂O each time, and dried over Na₂SO₄ and the methylene chloride is removed on a rotary evaporator. The residue is distilled in a copper pipe distillation apparatus at 0.02 torr and 170° C. to give 30 g of the title product.

A5) Synthesis of 2,2,6,6-tetramethyl-3,4-dehydro-4-allylpiperidine

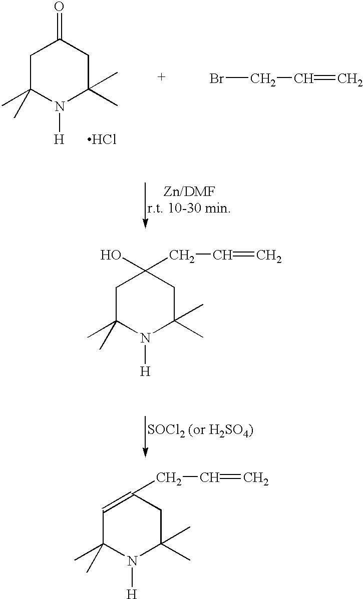

a) To a stirred solution of 5 g of 2,2,6,6-tetramethylpiperidone hydrochloride in 50 ml DMF and 6.31 g of allylbromide, 3.75 g of zinc powder are added. An exothermic reaction starts quite rapidly and it ceases within 20 minutes. Then most of the DMF is evaporated using reduced pressure and warming. The residue is then washed with chloroform and alkalized water. The chloroform phase is then collected and dried over Na₂SO₄, then the solvent is evaporated and the product distillated. During distillation the product crystallizes in the cooler and the receiving flask, yielding 4.3 g of 2,2,6,6-tetramethyl-4-hydroxy-4-allylpiperidine.

b) To the produced 2,2,6,6-tetramethyl-4-hydroxy-4-allylpiperidine is added dropwise 7.85 g of thionylchloride at room temperature; then the solution is heated to 50° C. for a period of 3 hours. Thionylchloride is evaporated and water followed by NaOH-solution and diethylether is added for extraction. The diethylether phase is dried with Na₂SO₄, evaporated and distilled under reduced pressure at 45-50° C. to give 1.8 g of 2,2,6,6-tetramethyl-3,4-dehydro-4-allylpiperidine.

A6) Preparation of 4-(but-3-enyl)-1,2,2,6,6-pentamethyl-3,4-dehydropiperidine

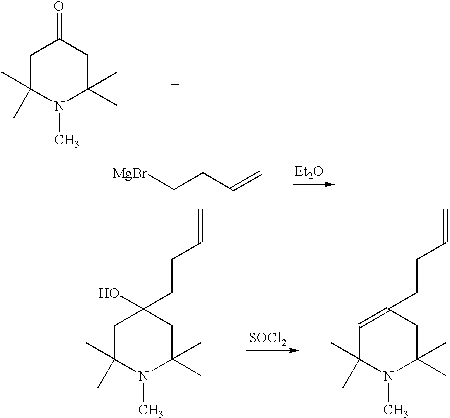

A Grignard reagent is prepared under argon atmosphere in the normal manner using 0.14 mol of magnesium turnings and 0.14 mol of 4-bromo-1-butene in 80 ml of THF. Then a solution of 1,2,2,6,6-pentamethyl-4-oxo-piperidine (0.12 mol) in 20 ml of THF is added dropwise. The reaction mixture is stirred overnight and poured into aqueous ammoniumchloride solution. The THF phase is separated and the water phase extracted with dichloromethane. The organic layers are dried over sodium sulfate and concentrated. After distillation under reduced pressure, 7.2 g (27%) of 4-(but-3-enyl)-4-hydroxyl-1,2,2,6,6-pentamethylpiperidine (bp 70° C./5 mmHg) is collected.

Subsequently, 7.2 g of 4-(but-3-enyl)-4-hydroxyl-1,2,2,6,6-pentamethylpiperidine are diluted in chloroform and 80 ml of thionyl chloride is added dropwise to the mixture under a blanket of argon. The mixture is heated to 60° C. and kept at that temperature under continued heating for 16 hours. After cooling to room temperature, the excess of thionyl chloride is evaporated and the residue is dissolved in water and then alkalized with an excess of 50% of sodium hydroxide solution. After extracting the water phase with ether, the solvent is removed and the product is distilled giving 2.5 g (37.5%) of 4-(but-3-enyl)-1,2,2,6,6-pentamethyl-3,4-dehydro-piperidine, which contains approximately 20% of 4-(but-3,1-dienyl)-1,2,2,6,6-pentamethylpiperidine isomer and the isomers were not separated (bp 90° C./10 mmHg). The isolated product exhibits the following spectral data: ¹H NMR (500 MHz, CDCl₃, TMS): 1.0 (d), 1.1 (s br, —CH₃, 6H), 1.1 (s br, —CH₃, 6H), 1.9 (s br, —C5H₂,2H), 2.0 (m, —CH₂—C═C, 2H), 2.1 (m br, —CH₂-piperidine), 2.2 (s, N—CH₃, 3H), 4.9-5.1 (m, ═CH 9, 2H), 5.2 (s br, C3H, 1 H), 5.7-5.9 (m, —CH═, 1 H). 13C NMR: 24.7, 26.8, 28.7, 31.7, 33.6, 43.8, 52.5, 54.9, 114.3, 130.4, 130.6 and 138.4. MS m/e (rel.int.) for the major compound: M⁺ 207 (1), 192, (100), 151 (12), 136 (13), 119 (4), 108 (3), 96 (2), 77 (4), 72 (3) and 56 (21). The MS m/e (rel.int.) for the minor compound shows peaks at M⁺ 207 (8), 193 (16)1, 192 (100), 136 (7), 119 (5), 93 (5), 77 (13), 72 (43), 56 (33) and 51 (7).

A7) Preparation of 1-(but-3-enyl)-2,2,6,6-tetramethylpiperidine A mixture of 2,2,6,6-tetramethylpiperidine (14.1 g, 0.1 mol) and 4-bromo-1-butene (16.2 g, 0.12 mol) in dioxane (11 ml) is refluxed for 1 day at 100° C. Then a piece of sodium is added and the mixture i stirred for additional 3 days at 100° C. The insoluble substances are separated by filtration and dioxane is removed under reduced pressure. Then diethyl ether is added and the organic layer washed with aqueous sodium carbonate, dried over anhydrous sodium sulfate and concentrated. Distillation under reduced pressure affords 3 g (15.4%) of 1-(but-3-enyl)-2,2,6,6-tetramethyl-piperidine (bp 62° C./10 mmHg). The product contains approximately 17.5% isomer, i.e. 1-(but-2-enyl)-2,2,6,6-tetramethylpiperidine and the isomers are not separated. ¹H NMR (500 MHz, CDCl₃, TMS): 5.7 (m, ═CH, 1H), 4.9 (m, ═CH₂, 2H), 2.4 (m, —N—CH₂—, 2H), 2.1 (m, ═C—CH₂—, 2H), 1.45 (m, C4H₂, 2H), 1.3 (m br, C3H₂ and C5H₂ ,4H), 0.9 (s, —CH₃, 12H). ³C NMR: 137,114.7,54.5,44.5, 41,1,40.3, 31.4and 17.7. MS m/e (rel.int.) for the major compound: 195 (2), 180 (27), 154 (100), 124 (16), 112 (5), 83 (7), 69 (69), 41 (59) and for the minor compound: 195 (5), 180 (100), 154 (1.5), 124 (15), 109 (7), 82 (5), 70 (27) and 55 (42).

A8) 1-(3,5-di-tert-butyl-4-hydroxybenzyl)-4-but-3-enyl-2,2,6,6-tetramethyl-3,4-dehydropiperidine

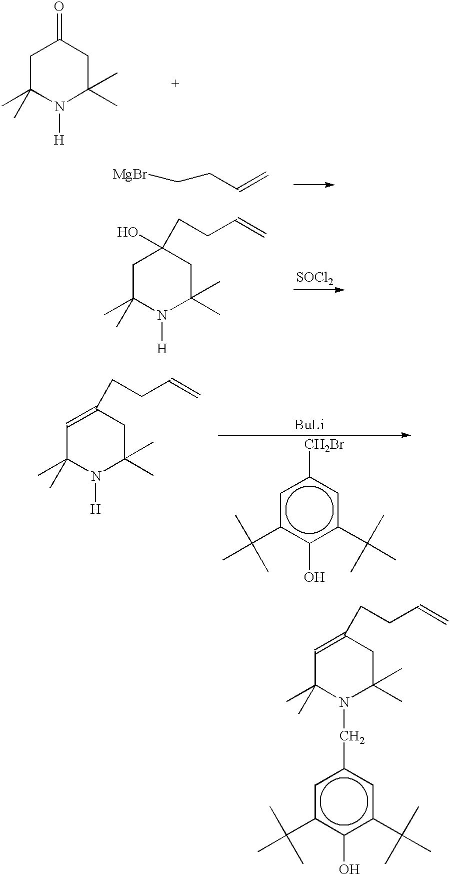

a) Preparation of 4-hydroxyl-4-(but-3-enyl)-2,2,6,6-tetramethylpiperidine:

A Grignard reagent is prepared under nitrogen atmosphere in the normal manner using 0.5 mol of magnesium turnings and 0.49 mol of 4-bromobuten in 200 ml of diethylether. Then a solution of 0.245 mol of 2,2,6,6-tetramethylpiperidone in diethylether is added dropwise to maintain refluxing. The reaction mixture is stirred for 12 h at room temperature and then the solution is acidified to pH 1 with 10% hydrochloridic acid. The aqueous phase is separated after washing it twice with diethylether. Then the aqueous phase is alkalized with an excess of ammonia solution and then the aqueous phase extracted with chloroform. The chloroform is then separated, dried and the solvent removed and 21 g (43.5%) of 4-hydroxyl-4-(but-3-enyl)-2,2,6,6-tetramethylpiperidine is obtained by vacuum distillation; 72-76° C./3 mmHg.

b) Preparation of 4-(but-3-enyl)-2,2,6,6-tetramethyl-3,4-dehydropiperidine:

To a solution of 21 g of 4-hydroxyl-4-(but-3-enyl)-2,2,6,6-tetramethylpiperidine in 210 ml of chloroform is added dropwise 219 g of thionyl chloride within 30 minutes at 50° C. The mixture is kept at this temperature for 4 hours under stirring. After cooling to 25° C. the excess of thionyl chloride is evaporated in vacuo. The residue is dissolved in 50 ml of water and then alkalized with an excess of sodium hydroxide solution. After extracting the aqueous phase with ether, the solvent is removed and the product distilled giving 12.9 g of 4-(but-3-enyl)-2,2,6,6-tetramethyl-3,4-dehydropiperidine at 80° C./10 mmHg.

c) Preparation of 1-(methylene-2,6-di-tert-butylphenol)-4-(but-3-enyl)-2,2,6,6-tetramethyldehydro-piperidine:

To (5.6 g, 31 mmol) of 4-(but-3-enyl)-2,2,6,6-tetramethyl-3,4-dehydropiperidine is added dropwise n-BuLi (10.3 ml of a 2.5 M solution in hexane, 26 mmol), and the reaction mixture is vigorously stirred for 30 minutes at −60° C. Then (7.7 g, 26 mmol) of 4-bromomethyl-2,6-di-tert-butylphenol diluted in 15 ml of hexane is added dropwise. After completed addition the reaction mixture is allowed to warm to room temperature, stirred over night and washed three times with water. The organic layer is dried over sodium sulfate and solvent is evaporated. Then the excess 2,2,6,6-tetramethylpiperidine is evaporated at 50° C./1 mmHg. The residue is dissolved in 50 ml mixture of hexane/water (1:1) and then acidified with HCl, whereby the desired product falls out as a salt. The salt is separated by filtration. After extracting the salt with ether and water which has been alkalized with sodium hydroxide, 2 q of raw 1-(methylene-2,6-di-tert-butylphenol)-4-(but-3-enyl)-2,2,6,6-tetramethylpiperidine are obtained.

A9) Preparation of 4-(2-(3-cyclohexenyl)ethyldimethylsiloxyl)-1,2,2,6,6-pentamethylpiperidine

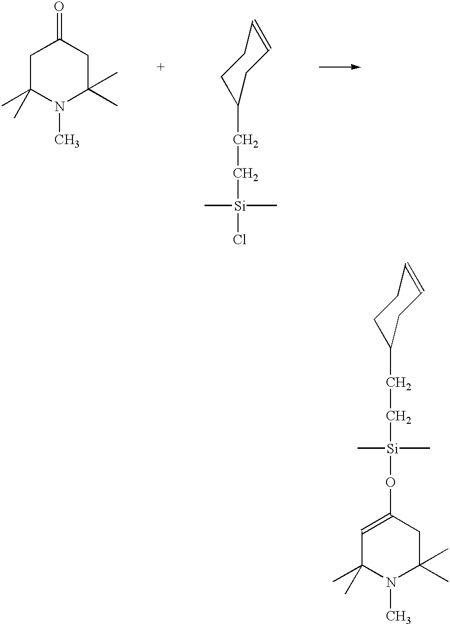

A solution of 1,2,2,6,6-pentamethyl-4-oxo-piperidine (10 g, 0.06 mol) and imidazol (4.1 g, 0.06 mol) in DMF (60 mL) is reacted with 2-(3-cyclohexenyl)-ethyldimethylchlorosilane) (13.8 g, 0.06 mol) and then stirred overnight at room temperature under a blanket of argon. The reaction mixture is treated with water and extracted with diethylether (2×150 mL). The combined organic phases are washed with water several times and dried over sodium sulfate. The solvents are removed under reduced pressure to leave an organic oil. Distillation under reduced pressure affords 7.9 g (38.9%) of 4-(2-(3-cyclohexenyl)ethyldimethylsiloxyl) -1,2,2,6,6-pentamethylpiperidine as a white liquid (bp 150° C./3 mmHg).

A10) (2,2,6,6-Tetramethyl-3,4-dehydropiperidine-4-yl)-(4-vinylphenyl)-methane

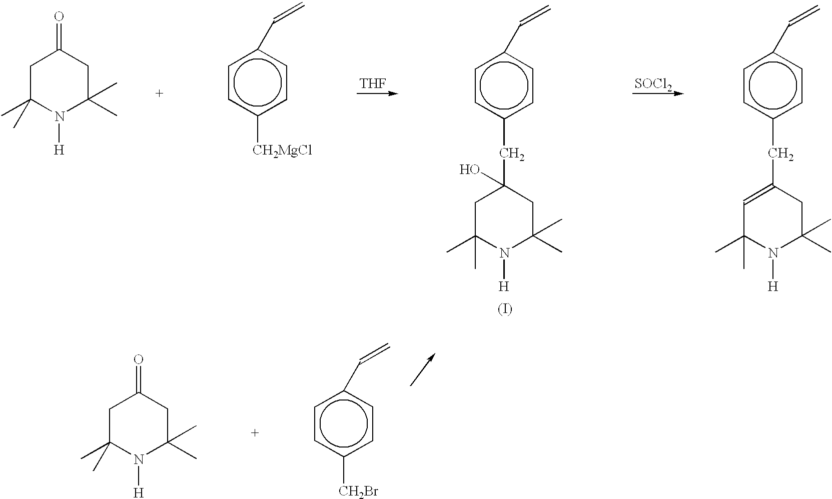

a) (2,2,6,6-Tetramethyl-4-hydroxypiperidine-4-yl)-(4-vinylphenyl)-methane (I) is prepared according to the procedure described in example A5(a) but using the equivalent amount of 4-vinylbenzylbromide instead of allylbromide.

The same compound is obtained using the same educt in a procedure as described in example A8(a).

b) Heating the above product together with thionyl chloride according to the procedure described in example A8(b) yields (2,2,6,6-Tetramethyl-3,4-dehydropiperidine-4-yl)-(4-vinylphenyl)-methane.

A11) Following the pathway described in example A7 but using an equivalent amount of 11-bromo-1-undecene instead of 4-bromo-1-butene yields 1-(undec-10-enyl)-2,2,6,6-tetramethylpiperidine.

A12) Preparation of 1-benzyl-2,2,6,6-tetramethyl-3,4-dehydropiperidine 75 g of concentrated sulfuric acid is added in portions to 24.5 g (0.15 mol) of 2,2,6,6-tetramethylpiperidinol. The mixture is warmed to 100° C. and stirred for 1.5 h. Then the mixture is allowed to cool down to room temperature and is added dropwise to a solution of 100 g sodium hydroxide in 250 ml of water. The water phase is extracted three times with 200 ml of dichloromethane. The combined organic extracts are dried over sodium sulfate and the solvent removed by evaporation. The residue is distilled to give 12.3 g (53%) of 2,2,6,6-tetramethyl-3,4-dehydropiperidine (bp. 149° C./760 mmHg). Then 38 g of benzyl bromide is added to 12.3 g (0.08 mol) of the prepared 2,2,6,6-tetramethyl-3,4-dehydropiperidine and heated at 150 UC for 3.5 h. The excess benzyl bromide is removed by evaporation and the residue is dissolved in benzene, washed with aqueous potassium carbonate and dried over anhydrous potassium carbonate. The benzene is removed and the residue distilled to give 8.2g (41%) of 1-benzyl-2,2,6,6-tetramethyl-3,4-dehydropiperidine (bp. 115° C./4 mmHg). ¹ H NMR (500 MHz, CDCl₃, TMS): 1.0 (s br, —CH₃, 6H), 1.1 (s br, —CH₃, 6H), 2.0 (s br, —C3H₂-piperidine, 2H), 3.8 (m, —CH₂-phenyl, 2H), 5.6 (m br, —CH═CH—, 2H), 7.1-7.4 (m, phenyl, 5H). ¹³C NMR: 41.1, 47.5, 53.5, 55.8, 120.2,125,6,126.6, 127.8,136.7 and 146.3. MS m/e (rel.int.): 229 (3), 214 (95), 172 (2), 145 (6), 122 (2), 91 (100), 65 (15) and 41 (10).

B) Preparation of Self-Stabilized Polymers

The sampling of the catalyst, activator and HALS monomer are carried out under nitrogen in a glovebox containing <2ppm oxygen and <5 ppm water. The reaction temperature is controlled by a circulating water bath within ±0.3° C. The amount of bound HALS is determined by elemental analyses after extracting the copolymers with refluxing 2-propanol/cyclohexane for 24 hours in a soxhlet apparatus. Comparative examples (V) correspond to polymerizations carried out without addition of HALS monomer.

### EXAMPLES B1-B17

250 ml of toluene dried over sodium are admixed with the amount of MAO stated in the respective table (for the molar ratio to the 0.011 mmol of Zr compound used in each case see the following tables). Half of this solution is charged to a thermostated 1-liter reactor where it is stirred for 5 minutes in order to neutralize any possible impurities. 0.000011 mol of zirconium compound (catalyst as indicated below) is added to the other half of the solution, and the mixture is stirred for 10 minutes (to activate the catalyst). The catalyst solution is transferred to the reactor and the polymerization is started by passing in ethylene or propylene. Following a predetermined period (usually 5 minutes) the HALS comonomer is added as a solution in 15 ml of toluene. After 60 minutes the autoclave is let down and the polymerization is terminated by adding 100 ml of methanol or ethanol. The copolymer is stirred in a mixture of 960 ml of ethanol and 40 ml of concentrated hydrochloric acid in order to remove catalyst residues and then washed twice with pure alcohol and dried in vacuo. The copolymer yield is determined by weighing. A portion of the copolymer is extracted in a Soxhlet extractor with an isopropanol/cyclohexane mixture, and the proportion of bonded HALS is determined by means of nitrogen analysis.

Comparative Examples C denote polymerizations without the use of HALS monomers.

The proportion of HALS comonomer used, and other details of polymerization and characterization of the product, are given in Tables 1 and 2 below;

Molecular weight determination by GPC; HALS-free comonomers are ethylene (Et) or propylene (Pr); temperatures are stated in ° C. Amounts based on Zr are molar fractions based on the molar fractions of Zr employed; amounts of HALS in the product are in % by weight of HALS monomer in the resultant copolymer.

The following catalysts are used:

Cat. 0: rac-(CH₃)₂Si(IndH₄)ZrCl₂, 33 mmol of methylaluminoxane

Cat. 1: rac-(CH₃)₂Si(IndH₄)₂ZrCl₂/methylaluminoxane

Cat. 2: rac-(CH₃)₂Si(Ind)₂ZrCl₂/methylaluminoxane

Cat. 3: rac-(1,4-butanediyl)₂Si(IndH₄)₂ZrCl₂/methylaluminoxane

Cat. 4: rac-C₂H₅(2-(t-butyldimethylsilyloxy) Ind)₂ZrCl₂/methylaluminoxane

Cat. 5: (CH₃) ₂C(fluorenyl)(cyclopentadienyl)ZrCl₂/methylaluminoxane

Cat. 6: rac-(CH₃) ₂Si(Ind)ZrCl₂/triphenylmethyl tetrakis(pentafluorophenyl)borane

TAB. 1
Copolymerization with ethylene; catalyst molar ratio Al/Zr = 3000

| Ex. | HALS monomer | Amount | Ethylene | Cat. type | Temp. | Product Mn | HALS in product |
|---|---|---|---|---|---|---|---|
| C1 | — | — | 1.6 bar | 0 | 25 | 28000 | — |
| B1 | A2 | 0.8 mmol | 1.6 bar | 0 | 25 | 18000 | 0.57% |
| C2 | — | — | 2 bar | 1 | 80 | 10300 | — |
| B2 | A3 | 47/Zr | 2 bar | 1 | 80 | 9300 | 0.5% |
| B3 | A3 | 106/Zr | 2 bar | 1 | 80 | 8400 | 1.7% |
| B4 | A3 | 102/Zr | 2 bar | 1 | 60 | 24100 | 1.3% |
| B5 | A3 | 102/Zr | 2 bar | 1 | 40 | 62300 | 3.6% |

TAB. 2
Copolymerization of monomer A3 with 2 bar of propylene

| | Amount of HALS | | | | Product | HALS in |
|---|---|---|---|---|---|---|
| Ex. | monomer/Zr | Cat. | Al/Zr | Temp. | Mn | product |
| C3 | 0 | 2 | 3000 | 20 | 30100 | — |
| B6 | 51 | 2 | 3000 | 20 | 22800 | 1.4 |
| B7 | 73 | 2 | 3000 | 20 | 15100 | 2.6 |
| B8 | 78 | 2 | 10000 | 20 | 27300 | 1.2 |
| C4 | 0 | 1 | 3000 | 20 | 3200 | — |
| B9 | 52 | 1 | 3000 | 20 | 10100 | 1.5 |
| C5 | 0 | 3 | 3000 | 20 | 26300 | — |
| B10 | 52 | 3 | 3000 | 20 | 6300 | 1.3 |
| C6 | 0 | 4 | 3000 | 20 | 8000 | — |
| B11 | 50 | 4 | 3000 | 20 | 7000 | 0.4 |
| B12 | 270 | 4 | 10000 | 20 | 2500 | 3.4 |
| C7 | 0 | 5 | 3000 | 20 | 54700 | — |
| B13 | 46 | 5 | 3000 | 20 | 32100 | 1.1 |
| C8 | 0 | 6 | 3000 | −20 | 34000 | — |
| B14 | 36 | 6 | 3000 | −20 | 19200 | 0.8 |
| B15 | 37 | 6 | 3000 | −20 | 19500 | 0.8 |
| C9 | 0 | 1 | 3000 | 80 | 10300 | — |
| B16 | 49 | 1 | 3000 | 80 | 8400 | 0.5 |
| B17 | 97 | 1 | 3000 | 80 | 9300 | 2 |

### EXAMPLES B18-B66

Slurry polymerizations are carried out in a 0.5 L jacketed glass autoclave (Büchi, Switzerland) equipped with a blade turbine stirrer. The dry glass autoclave is evacuated and backflushed with nitrogen. This procedure is repeated several times. Then 250 ml of freshly distilled toluene is pumped into the autoclave. Half of the methylalumoxane/toluene solution to be used is added to the reactor together with HALS monomer and stirred for 30 minutes. After 25 minutes the metallocene catalyst is dissolved in the remaining amount of the MAO/toluene solution and preactivated for 5 minutes by standing at room temperature. Then the catalyst/activator mixture is charged into the reactor by using ethylene or propylene overpressure. The pressure of ethylene or propylene is kept constant by controlling the gas feed automatically over the entire reaction period with a Büchi Pressflow Gas Controller Model bpc 1202. After 20 or 60 minutes the copolymerization is quenched by rapidly venting ethylene or propylene and adding 100 ml of ethanol. The catalyst residues of the produced copolymer is removed by treatment with ethanol/HCl(aq) solution over night. After filtration, the polyolefin is washed twice with ethanol and stirred over night in a NaOH(aq)/ethanol solution. Then the polyolefin is washed again twice with ethanol, dried in vacuum and weighed to determine the polymerization yield.

The copolymerizations with the MAO-free cationic catalyst system are carried out at −20° C. and 2.0 bar propylene pressure using triethylaluminium (TEA) as impurity scavenger and alkylating agent. The alkylated catalyst precursor is generated in situ. In a typical run 0.3 g of TEA is stirred with 50 ml of toluene and the appropriate amount of HALS monomer for 30 minutes followed by the addition of 5 mmol of the metallocene catalyst. The copolymerization is initiated by flushing the cation-forming agent (trityl tetra(perfluoro-phenyl)borate (TRI-FABA) or N,N-dimethyl-anilinium tetra(perfluorophenyl)borate (DAN-FABA)) with propylene overpressure. The copolymerization is interrupted after 60 minutes and subjected to the same washing procedure as described previously.

The copolymerizations over the silica supported metallocene catalyst system are performed at 80° C. and 5 bar ethylene pressure in 300 ml pentane. In addition 0.3 grams of TIBA (triisobutylaluminium) was used as an impurity scavenger and external activator. The catalyst suspension (100 mg of supported catalyst in 5 ml of pentane) is flushed with ethylene overpressure into the reactor to start the copolymerization. The copolymerization is interrupted after 180 minutes and subjected to the same washing procedure as described previously.

Metallocene catalysts: rac-[dimethylsilylenebis(1-indenyl)]zirconium dichloride (CA1) rac-[dimethylsilylenebis(4,5,6,7-tetrahydro-1-indenyl)]zirconium dichloride (CA2),

rac-[ethylenebis(4,5,6,7-tetrahydro-1-indenyl)]zirconium dichloride (CA4),

rac-[dimethylsilylenebis(2-methyl-4,5-benzoindenyl)]zirconium dichloride (CA6), isopropyl(cyclopentadienyl-1-fluorenyl)zirconium dichloride (CA7) and

rac-[ethylenebis(2-(tert-butyidimethylsiloxyl-1-indenyl)]zirconium dichloride (CA8) are synthesized according to procedures described in

Herrmann et al., Angew. Chem., Int. Ed. Engl., 28, 1511 (1989);

Herrmann et al., Angew. Chem. 101, 1536 (1989);

Spaleck et al., Organometallics 13, 954 (1994);

Ewen et al., J. Am. Chem. Soc. 110, 6255 (1988)

Leino et al., Organometallics 15, 2450 (1996).

Rac-[ethylenebis(1-indenyl)]zirconium dichloride (CA3) and bis(pentamethyl-η⁵-cyclopentadienyl)zirconium dichloride (C5) are purchased from Strem and Aldrich, respectively and used as received.

The rac-[ethylenebis(2-(tert-butyidimethylsiloxyl-1-indenyl)]zirconium dichloride catalyst is supported on silica according to the procedure described in WO 94/28034.

The following tables 3 and 4 show results obtained for ethylene copolymerization. Terpolymers obtained with ethylene, HALS and 35 mmol of 1-hexene in 250 ml of toluene are described in table 5. Tables 6 and 7 summarize results of propylene copolymerization using different metallocene/MAO catalyst systems (table 6) or CA2/triethyl aluminum/borate catalyst systems (table 7). Bound N denotes the amount of nitrogen in % by weight of the polymer product as detected by elementary analysis.

TAB. 3
Copolymerization of ethylene (2 bar) over CA2/MAO catalyst system
(Al/Zr = 3000)/250 ml toluene for 20 min.;
Temperature 80° C. or as indicated

| | HALS | HALS/Zr | Zr | Product | bound N | % HALS |
|---|---|---|---|---|---|---|
| Ex. | of Ex. | mol/mol | μmol/l | Mn | (of HALS) | conversion |
| V10 | — | — | 42 | 10300 | — | — |
| B18 | A7 | 50 | 47 | 12200 | 0.4 | 100 |
| B19 | A7 | 150 | 44 | 10600 | 0.8 | 54 |
| B20 | A7 | 600 | 43 | 7100 | 5.4 | 63 |
| B21 | A11 | 50 | 44 | 11900 | 0.7 | 100 |
| B22 | A11 | 150 | 43 | 12200 | 2.0 | 94 |
| B23 | A11 | 600 | 44 | 9200 | 6.4 | 83 |
| B24 | A11 | 1200 | 45 | 5700 | 11.5 | 74 |
| B25 | A11 | 1875 | 42 | | 14.1 | 61 |
| B26 | A6 | 60 | 46 | 14100 | 0.8 | 100 |
| B27 | A6 | 120 | 45 | 15300 | 1.6 | 65 |
| B28 | A6 | 180 | 44 | 14900 | 1.9 | 63 |
| B29 | A2 | 110 | 31 | 18100 | 0.2 | |
| B30 | A3 | 50 | 48 | 9600 | 0.5 | 100 |
| B31 | A3 | 100 | 45 | 8400 | 1.7 | 93 |
| B32 | A3 | 165 | 45 | | | |
| B33* | A3 | 110 | 45 | 61400 | 1.3 | 85 |
| B34** | A3 | 100 | 47 | 121000 | 3.6 | 73 |
| B35 | A4 | 50 | 46 | 8400 | 0.5 | 100 |
| B36 | A4 | 100 | 46 | 9300 | 2.0 | 100 |
| B37 | A4 | 150 | 45 | 1500 | 8.0 | 35.6 |
| B38* | A4 | 100 | 44 | 50600 | 1.7 | 100 |
| B39** | A4 | 100 | 45 | 102000 | 5 | 70 |

*Temperature during polymerization 60° C.
**Temperature during polymerization 40° C.

TAB. 4
Copolymerization of ethylene (5 bar) over (CA5)/SiO₂/MAO catalyst
system (MAO/Zr = 100)/300 ml pentane for 180 min. at 80° C.

| | HALS | HALS/Zr | | bound N | % HALS |
|---|---|---|---|---|---|
| Ex. | of Ex. | mol/mol | Product Mn | (of HALS) | conversion |
| V11 | — | — | 55500 | — | — |
| B40 | A11 | 550 | 57400 | 0.1 | 18 |

TAB. 5
Terpolymerization with ethylene (2 bar) and 1-hexen over CA2/MAO catalyst system
(Al/Zr = 3000)/250 ml toluene for 20 min. at 80° C.

| Ex. | HALS of Ex. | HALS/Zr mol/mol | [hexen] mol/l | Zr μmol/l | Product Mn | bound N (of HALS) | % HALS conversion |
|---|---|---|---|---|---|---|---|
| V12 | — | — | — | 42 | 10300 | — | — |
| V13 | — | — | 0.14 | 27 | 7400 | — | —. |
| B41 | A11 | 243 | 0.14 | 27 | 3500 | 1.2 | 57 |
| B42 | A11 | 972 | 0.14 | 27 | 3900 | 4.7 | 60 |
| B43 | A11 | 2040 | 0.14 | 25 | 3200 | 11.4 | 56 |
| B44 | A11 | 3160 | 0.14 | 25 | 2500 | 15.9 | 53 |

TAB. 6
Copolymerization of propylene (2 bar) over different metallocene/MAO catalyst
systems (Al/Zr = 3000; 250 ml toluene; 60 min; 80° C.)

| Ex. | HALS of Ex. | HALS/Zr mol/mol | Catalyst | Zr μmol/l | Product Mn | bound N (of HALS) | % HALS conversion |
|---|---|---|---|---|---|---|---|
| V14 | — | — | CA1 | 44 | 30100 | — | — |
| B45 | A3 | 49 | CA1 | 46 | 16900 | 2.4 | 77 |
| B46 | A4 | 51 | CA1 | 44 | 22800 | 1.4 | 67 |
| V15 | — | — | CA2 | 44 | 32000 | — | — |
| B47 | A3 | 50 | CA2 | 48 | 3300 | 2.0 | 64 |
| B48 | A4 | 52 | CA2 | 44 | 10100 | 1.5 | 78 |
| V16 | — | — | CA3 | 46 | 10000 | — | — |
| B49 | A3 | 49 | CA3 | 46 | 4800 | 2.7 | 63 |
| B50 | A4 | 47 | CA3 | 50 | 6900 | 1.4 | 80 |
| V17 | — | — | CA4 | 46 | 16500 | — | — |
| B51 | A3 | 45 | CA4 | 50 | 2300 | 1.6 | 52 |
| B52 | A4 | 47 | CA4 | 48 | 3600 | 1.4 | 80 |
| V18 | — | — | CA5 | 44 | * | — | — |
| B53 | A3 | 48 | CA5 | 45 | * | | |
| V19 | — | — | CA6 | 29 | 67300 | — | — |
| B54 | A3 | 58 | CA6 | 37 | 26000 | 1.6 | 55 |
| B55 | A4 | 66 | CA6 | 34 | 55300 | 0.9 | 53 |
| V20 | — | — | CA7 | 47 | 54700 | — | — |
| B56 | A3 | 47 | CA7 | 47 | 18700 | 1.9 | 45 |
| B57 | A4 | 46 | CA7 | 49 | 32100 | 1.1 | 52 |
| V21 | — | — | CA8 | 47 | 8000 | — | — |
| B58 | A3 | 50 | CA8 | 45 | | 0.4 | 40 |
| B59 | A4 | 47 | CA8 | 48 | 8300 | 1.2 | 72 |

* Atactic oligomeric polypropylene/poly(propylene-co-A3) copolymer

TAB. 7
Copolymerization of propylene (2 bar) over CA2/TEA/borate cocatalyst system*
(Al = 33 mmol/l; 250 ml toluene; 20 min; −20° C.)

| Ex. | HALS of Ex. | HALS/Zr mol/mol | Cocatalyst* [mol/mol HALS] | Zr μmol/l | Product Mn | bound N (of HALS) | % HALS conversion |
|---|---|---|---|---|---|---|---|
| V22 | — | — | T | 90 | 34000 | — | — |
| V23 | — | — | D | 92 | | — | — |
| B60 | A3 | 36 | T [1.05] | 89 | 19200 | 0.7 | 90 |
| B61 | A3 | 38 | D [1.0] | 89 | | | |
| B62 | A3 | 38 | D [1.5] | 89 | | | |
| B63 | A4 | 39 | T [1.1] | 86 | 20500 | 1.8 | 22 |
| B64 | A11 | 150 | T [0.1] | 87 | | 1.7 | 23 |
| B65 | A11 | 96 | T [0.2] | 89 | | 1.2 | 42 |
| B66 | A11 | 48 | T [0.3] | 89 | | 1.1 | 81 |

*Borate cocatalysts are TRI-FABA (T) or DAN-FABA (D)

C) Stabilization of Organic Material

### EXAMPLE C1

### Stabilization of Polypropylene

The polymers set out in Tables 8 and 9 are diluted to a HALS monomer fraction of 0.1 or 0.2% by weight with polypropylene powder (Profax™ 6501) in a Brabender Plastograph™ at 200° C. for 10 minutes. Costabilizers incorporated in addition are 0.1% calcium stearate, 0.1% tris(2,4-di-tert-butylphenyl) phosphite and either 0.05% pentaerythrityl tetrakis(3-[3′,5′-di-tert-butyl-4′-hydroxyphenyl]propionate (costabilization type a) or 0.02% octadecyl 3-[3′,5′-di-tert-butyl-4′-hydroxyphenyl]propionate (costabilization type b).

The composition obtained in this way is pressed in a press with a surface temperature of 230° C. into plates 1 mm thick from which strips 1 cm wide and 10 cm long are punched. For comparison purposes, a further sample is produced without stabilizers. 5 such strips from each plate are suspended in a circulating-air oven heated at 135° C. and are examined at regular intervals of time for embrittlement, by flexure. The oxidative decomposition of these strips is evident from the fracture of the strip. The period of time, in days, until fracture is a measure of the stability of the sample.

TABLE 8
Period of time (in days) to fracture of the samples

| | | | Number of days of oven |
|---|---|---|---|
| Stabilizer | HALS mono- | Costabili- | ageing before |
| from Ex. | mer fraction | zation type | decomposition |
| B8 | 0.1% | a | 23 |
| B14 | 0.1% | b | 15 |

Material of the same kind as described above is processed conventionally to films 0.1 mm thick (pressing conditions 3 minutes at 260° C., followed by quenching in cold water).

The films are exposed against a white background using an apparatus of the Weather—O—Meter™ 65WR type (Atlas Corp.) at a black standard temperature of 65° C. The oxidation process is monitored by means of a Fourier transform infrared spectrometer (carbonyl absorbance). High carbonyl absorbance denotes severe decomposition of the polymer. The period of time, in hours, until a carbonyl absorbance of 0.1 is reached is shown in Table 4 below.

TABLE 9
Exposure period (in hours) until carbonyl absorbance of 0.1

| Stabilizer | HALS mono- | Costabili- | Exposure period |
|---|---|---|---|
| from Ex. | mer fraction | zation type | (hours) |
| B8 | 0.1% | a | 2000 |
| B8 | 0.2% | a | 2500 |
| B14 | 0.1% | b | 2500 |
| B14 | 0.2% | b | 3900 |

### Example C2

### Stabilization of Polyethylene

The polymers specified in Table 10 are diluted to a HALS monomer fraction of 0.1% by weight with polyethylene powder (Statoil™ H 870) in a Brabender Plastograph™ at 180° C. for 10 minutes. Costabilizers incorporated in addition are 0.1% calcium stearate, 0.1% tris(2,4-di-tert-butylphenyl) phosphite and 0.02% octadecyl 3-[3′,5′-di-tert-butyl-4′-hydroxyphenyl]propionate.

The composition obtained in this way is pressed in a press with a surface temperature of 200° C. to form plates 1 mm thick from which strips 1 cm wide and 10 cm long are punched. For comparison purposes a further sample is produced without stabilizers. 5 such strips from each plate are suspended in a circulating-air oven heated at 120° C., and are examined at regular intervals of time for embrittlement, by flexure. The oxidative decomposition of these strips is evident from the fracture of the strip. The period of time, in days, to fracture is a measure of the stability of the sample,

TABLE 10
Period of time (in days) until fracture

| Stabilizer | HALS mono- | Number of days of oven |
|---|---|---|
| from Ex. | mer fraction | ageing before decomposition |
| B3 | 0.1% | 115 |

C3) Durability of Modified Polymer

Thermo-oxidative stability of polymers identified in the following table 10 is determined by oven aging at 115° C. in an air atmosphere in combination with FTIR analyses. The copolymer is extracted with both refluxing isopropanol/cyclohexane and chloroform in a soxhlet apparatus for 24 hours prior to stability tests. The copolymer exhibits high thermo-oxidative stability in comparison to unstabilized polyethylene, i.e. for the copolymer the carbonyl peak do not appear after 1 year of oven aging at 115° C., whereas unstabilized polyethylene shows a strong carbonyl peak within 2 days, as shown.

TABLE 10
Time for formation of carbonyl peak (FTIR)

| (Co)polymer | bound nitrogen | | IR carbonyl peak | |
|---|---|---|---|---|
| of Example | (wt. %) | | detectable after | |
| V10 | 0 | | 48 | h |
| B29 | 0.2 | > | 8544 | h |

What is claimed is:

1. A process for preparing a polymer or copolymer by addition polymerization of an ethylenically unsaturated sterically hindered amine or of an ethylenically unsaturated sterically hindered amine and a further ethylenically unsaturated monomer, which comprises conducting the polymerization in the presence of a catalyst of the metallocene type.

2. A process according to claim 1, wherein the ethylenically unsaturated sterically hindered amine includes a carbon-carbon double bond and a group of the formula 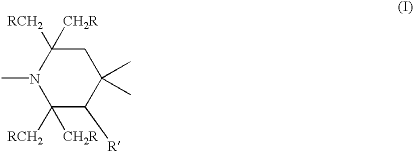
in which R and R′ are H, C₁-C₁₂alkyl or C₅-C₁₂cycloalkyl or adjacent radicals R, together with the connecting carbon atoms, form a cyclopentyl or cyclohexyl ring, and one of R and R′ can alternatively be C₂-C₁₂alkenyl or C₅-C₈cycloalkenyl- or C₆-C₉bicycloalkenyl-substituted C₁-C₈alkyl, or R′, together with one of the bonds in position 4, can form an ethylenic double bond within the ring structure.

3. A process according to claim 1, wherein the ethylenically unsaturated sterically hindered amine is a compound of the formula Ia 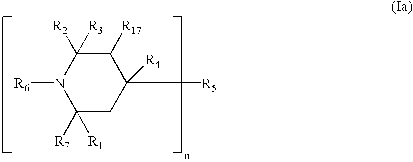
in which n is 1 or 2; R₁, R₂ and R₃ are C₁-C₄alkyl; or R₂ and R₃ together are C₄-C₁₁ alkylene;
R₄ and R₁₇ are hydrogen or R₄ together with R₁₇ is a chemical bond and R₅, if n=1, is hydrogen, OH, C₁-C₁₈alkyl, C₇-C₁₅phenylalkyl, C₃-C₁₂alkenyl, C₅-C₁₂cycloalkyl, cyclohexenyl, acryloyloxy, acryloylamido, phenylene- or cyclohexylene-interrupted C₁-C₁₈alkyl or C₃-C₁₂alkenyl, or is a radical of the formula —X—(CO)ᵢ—R₈ or of the formula —O—Si(R₁₈)(R₁₉)(R₂₀) or, if R₁₇ is hydrogen, R₄ and R₅ together are ═O; the index i being 0 or 1;
and R₅, if n=2, is a radical of the formula —X—CO—R₁₀—CO—X;
R₆ is hydrogen, C₁-C₁₈alkyl, C₃-C₈alkenyl, C₇-C₁₁phenylalkyl, or C₇-C₁₁phenylalkyl substituted on the phenyl ring by C₁-C₁₂alkyl and/or OH;
R₇ is C₃-C₁₂alkenyl or C₁-C₄alkyl; or R₇ and R₁ together are C₄-C₁₁alkylene;
R₈ is C₁-C₁₈alkyl, C₃-C₁₂alkenyl, C₇-C₁₅phenylalkyl, C₈-C₁₅phenylalkenyl, C₇-C₁₅phenylalkyl substituted in the phenyl moiety by C₁-C₄alkyl or C₂-C₄alkenyl or C₁-C₄alkoxy, or is phenyl or C₁-C₄alkyl- or C₂-C₄alkenyl- or C₁-C₄alkoxy-substituted phenyl;
R₉ is C₁-C₁₂alkyl or C₅-C₁₂cycloalkyl;
R₁₀ is a direct bond, C₁-C₁₂alkylene or C₂-C₁₂alkenylene, or phenyl- or naphthyl-substituted C₂-C₁₂alkenylene; R₁₈ and R₁₉ independently of one another are C₁-C₈alkyl;
R₂₀ is a hydrocarbon radical containing 1 to 18 carbon atoms;
X is —NH—, —NR₉— or —O—; with the proviso that the compound of the formula Ia comprises an ethylenical double bond.

4. A process according to claim 1, wherein a homopolymer is prepared by addition polymerization of an ethylenically unsaturated sterically hindered amine or a copolymer is prepared by addition polymerization of an ethylenically unsaturated sterically hindered amine and 10-99.9% by weight, based on the total copolymer weight, of an ethylenically unsaturated monomer of the formula II 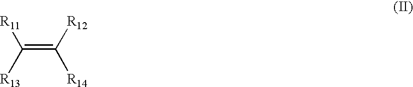
in which
R₁₁, R₁₂ and R₁₃ independently of one another are hydrogen; —Cl; C₁-C₁₈alkyl; phenyl; phenyl substituted from 1 to 3 times by —Cl, C₁-C₄alkyl and/or C₁-C₄alkoxy; or are C₇-C₉phenylalkyl; and
R₁₄ is as defined for R₁₁, R₁₂ or R₁₃ or is —CN; C₁-C₁₂alkyloxycarbonyl; C₁-C₁₂alkanoyloxy; or C₁-C₁₂alkoxy.

5. A process according to claim 1, wherein the system employed as metallocene catalyst consists of
A-1) a metallocene compound and
A-2) an aluminoxane or an ion exchange compound.

6. A process according to claim 5, wherein the aluminoxane of component A-2 is of the formula (III) 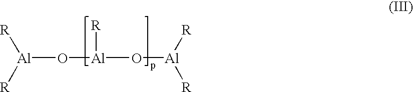
and/or of the formula (IV) 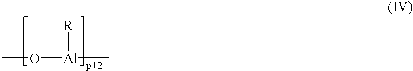
in which formulae (Ill) and (IV) R is identical or different and is C₁-C₆alkyl, C₆-C₁₈aryl, benzyl or hydrogen, and p is an integer from 2 to 50.

7. A process according to claim 1, wherein the metallocene catalyst is selected from the compounds
a) of the formula A
{[(R₂₁)(R₂₂M)ₐ]^{an+}an/q[LQₘ]^{q-}} (A),
in which a is 1 or 2 and n and q independently of one another are each an integer from 1 to 4, M is the cation of a monovalent to tetravalent metal from transition elements group IVb to VIIb, VIII or Ib of the Periodic Table of the Elements, m is an integer corresponding to the valency of L+q, Q is a halogen atom, L is a divalent to heptavalent metal or nonmetal, R₂₁ is a π-arene and R₂₂ is a π-arene or the anion of a π-arene;
b) hemimetallocenes comprising a cyclopentadienyl anion attached to a transition metal cation;
c) compounds of the formula 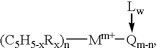
in which
M^{m+} is an m-valent cation of a transition metal of groups IVb, Vb or VIb of the Periodic Table; (C₅H₅₋ₓRₓ) is a cyclopentadienyl ring which is substituted by from zero to five substituents R; x is a number zero, one, two, three, four or five;
n is one or two;
R, independently at each occurrence, is a C₁-C₂₀hydrocarbon radical, a C₁-C₂₀hydrocarbon radical substituted by a halogen atom, a metalloid-substituted C₁-C₂₀hydrocarbon radical, or halogen; or two adjacent radicals R are a C₄-C₂₀ ring; or, if n is 1, R is a radical B_{y}-JR′_{z-1-y}, in which
J is an element from main group VA of the Periodic Table having the coordination number 3 or an element from main group VIA of the Periodic Table having the coordination number 2;
R′, independently at each occurrence, is a C₁-C₂₀hydrocarbon radical or is a C₁-C₂₀hydrocarbon radical substituted by a halogen atom;
z is the coordination number of the element J;
y is zero or one;
B, if y is one, is a bridge comprising an element of main group IVA or VA of the Periodic Table;
or R, if n is two, is a group selected from —M₂(R₁₀)(R₁)—, —M₂(R₁₀)(R₁₁)—M₂(R₁₀)(R₁₁)—, —C(R₁₀)(R₁₁)—C(R₁₀)(R₁₁)—, —O—M₂(R₁₀)(R₁l)—O—, —C(R₁₀)(R₁₁)—, —O—M₂(R₁₀)(R₁₁)—, —C(R₁₀)(R₁₁)—M₂(R₁₀)(R₁₁)—, —B(R₁₀)—, —Al(R₁₀)—, —Ge—, —Sn—, —O—, —S—, —S(O)—, —S(O)₂—, —N(R₁₀)—, —C(O)—, —P(R₁₀)— or —P(O)(R₁₀)—;
where
R₁₀ and R₁₁ are identical or different and are a hydrogen atom, a halogen atom, a C1-C₁₀alkyl group, a C₁-C₁₀fluoroalkyl group, a C₆-C₁₀aryl group, a C₆-C₁₀fluoroaryl group, a C₁-C₁₀alkoxy group, a C₂-C₁₀alkenyl group, a C₇-C₄₀arylalkyl group, a C₈-C₄₀arylalkenyl group, or a C₇-C₄₀alkylaryl group, or R₁₀ and R₁₁, in each case with the atoms connecting them, form a ring, and
M₂ is silicon, germanium or tin,
Q, independently at each occurrence, is hydrogen, a C₁-C₅₀hydrocarbon radical, a C₁-C₅₀hydrocarbon radical substituted by an electron-withdrawing group, or is a metalloid-substituted C₁-C₅₀hydrocarbon radical, the metalloid being an element of main group IVA of the Periodic Table, with the exception of hydrocarbon radicals of the formula (C₅H₅₋ₓRₓ); or
two radicals Q are alkylidene, olefin, acetylene or a cyclometallated hydrocarbon radical;
L is a neutral Lewis base; and
w is a number from 0 to 3;
d) compounds of the formula 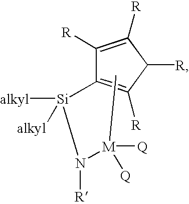
where M is Ti or Zr and the
other substituents are as indicated above;
e) compounds of the formula C 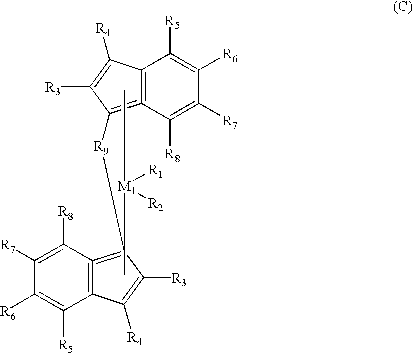
in which
M₁ is a transition metal of group IVb, Vb or VIb of the Periodic Table;
R₁ and R₂ are identical or different and are a hydrogen atom, a C₁-C₁₀alkyl group, a C₁-C₁₀alkoxy group, a C₆-C₁₀aryl group, a C₆-C₁₀aryloxy group, a C₂-C₁₀alkenyl group, a C₇-C₄₀arylalkyl group, a C₇-C₄₀alkylaryl group, a C₈-C₄₀arylalkenyl group, an OH group or a halogen atom,
the radicals R₃ are identical or different and are a hydrogen atom, a halogen atom, a C₁-C₁₀alkyl group which can be halogenated, an C₆-C₁₀aryl group, a —NR₂, —SR, —OSiR₃, —SiR₃ or PR₂ radical, in which R is a halogen atom, a C₁-C₁₀alkyl group or a C₆-C₁₀aryl group;
R₄ to R₈ are as defined for R₃, or adjacent radicals R₄ to R₈, with the atoms connecting them, form an aromatic or aliphatic ring,
R₉ is a group selected from —M₂(R₁₀)(R₁₁)—, —M₂(R₁₀)(R₁₁)—M₂(R₁₀)(R₁₁)—, —C(R₁₀)(R₁₁)—C(R₁₀)(R₁₁)—, —O—M₂(R₁₀)(R₁₁)—O—, —C(R₁₀)(R₁₁)—, —O—M₂(R₁₀)(R₁₁)—, —C(R₁₀)(R₁₁)—M₂(R₁₀)(R₁₁)—, —B(R₁₀)—, —Al(R₁₀)—, —Ge—, —Sn—, —O—, —S—, —S(O)—, —S(O)₂—, —N(R₁₀)—, —C(O)—, —P(R₁₀)— or —P(O)(R₁₀)—; where
R₁₀ and R₁₁ are identical or different and are a hydrogen atom, a halogen atom, a C₁-C₁₀alkyl group, C₁-C₁₀fluoroalkyl group, a C₆-C₁₀aryl group, a C₆-C₁₀fluoroaryl group, a C₁-C₁₀alkoxy group, a C₂-C₁₀alkenyl group, a C₇-C₄₀arylalkyl group, a C₈-C₄₀arylalkenyl group, a C₇-C₄₀alkylaryl group, or R₁₀ and R₁₁, each with the atoms connecting them, form a ring, and
M₂ is silicon, germanium or tin; and
f) compounds of the formula (D) 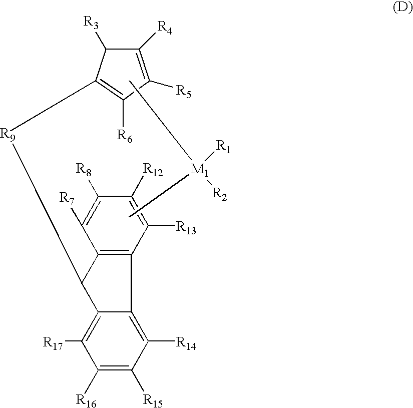
in which
M₁ is a transition metal of group IVb, Vb or VIb of the Periodic Table;
R₁ and R₂ are identical or different and are a hydrogen atom, a C₁-C₁₀alkyl group, a C₁-C₁₀alkoxy group, a C₆-C₁₀aryl group, a C₆-C₁₀aryloxy group, a C₂-C₁₀alkenyl group, a C₇-C₄₀arylalkyl group, a C₇-C₄₀alkylaryl group, a C₈-C₄₀arylalkenyl group, an OH group or a halogen atom,
the radicals R₃ are identical or different and are a hydrogen atom, a halogen atom, a C₁-C₁₀alkyl group which can be halogenated, a C₆-C₁₀aryl group, an —NR₂, —SR, —OSiR₃, —SiR₃ or PR₂ radical, in which R is a halogen atom, a C₁-C₁₀alkyl group or a C₆-C₁₀aryl group;
R₄ to R₈ are as defined for R₃, or adjacent radicals R₄ to R₈, with the atoms connecting them, form an aromatic or aliphatic ring,
R₉ is a group selected from —M₂(R₁₀)(R₁₁)—, —M₂(R₁₀)(R₁₁)—M₂(R₁₀)(R₁₁)—, —C(R₁₀)(R₁₁)—C(R₁₀)(R₁l)—, —O—M₂(R₁₀)(R₁₁)—O—, —C(R₁₀)(R₁₁)—, —O—M₂(R₁₀)(R₁₁)—, —C(R₁₀)(R₁₁)—M₂(R₁₀)(R₁₁)—, —B(R₁₀)—, —Al(R₁₀)—, —Ge—, —Sn—, —O—, —S—, —S(O)—, —S(O)₂—, —N(R₁₀)—, —C(O)—, —P(R₁₀)— or —P(O)(R₁₀)—; where
R₁₀ and R₁₁ are identical or different and are a hydrogen atom, a halogen atom, a C₁-C₁₀alkyl group, C₁-C₁₀fluoroalkyl group, a C₆-C₁₀aryl group, a C₆-C₁₀fluoroaryl group, a C₁-C₁₀alkoxy group, a C₂-C₁₀alkenyl group, a C₇-C₄₀arylalkyl group, a C₈-C₄₀arylalkenyl group, a C₇-C₄₀alkylaryl group or R₁₀ and R₁₁, in each case with the atoms connecting them, form a ring, and
M₂ is silicon, germanium or tin; and
R₁₂ to R₁₇ are as defined for R₃.

8. A process according to claim 7, wherein M and M₁ are a transition metal of group IVb, Vb or VIb of the Periodic Table selected from the metals titanium, zirconium, hafnium, vanadium, niobium, tantalum, chromium, molybdenum or tungsten; J is N, P, O or S;
B, if y is one, is C₁-C₂₀alkylene, a di-C₁-C₂₀alkyl-, C₇-C₂₀alkylaryl- or di-C₆-C₂₀aryl-silicon or -germanium radical, or an alkyl- or aryl-phosphine or amine radical;
Q as an electron-withdrawing group is halogen or alkoxy;
L as a neutral Lewis base is diethyl ether, tetrahydrofuran, dimethylaniline, aniline,
trimethylphosphine or n-butylamine.

9. A polymer or copolymer obtainable by a process according to claim 1.

10. A compound of the formula V, VI, VII or VIII 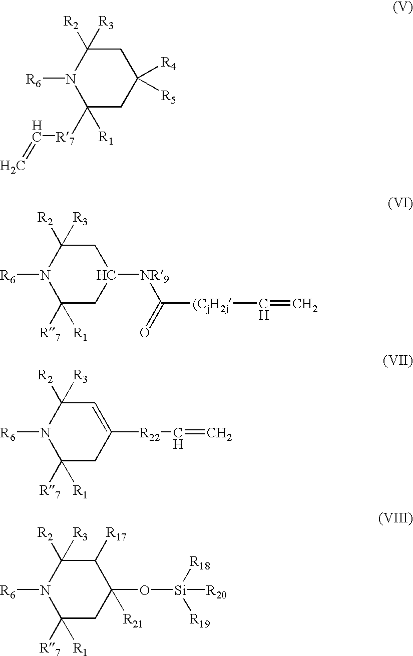
in which R₁, R₂ and R₃ are C₁-C₄alkyl; or R₂ and R₃ together are C₄-C₁₁ alkylene;
R₄ is hydrogen;
R₅ is hydrogen, OH, C₁-C₁₈alkyl, C₃-C₁₂alkenyl, acryloyloxy, acryloylamido, or is a radical of the formula —X—(CO)ᵢ—R₈, where i is 0 or 1; or R₄ and R₅ together are ═O;
R₆ is hydrogen, C, —C₁₈alkyl, C₃-C₈alkenyl, C₇-C₁₁ phenylalkyl, or C₇-C₁₁ phenylalkyl substituted on the phenyl ring by C₁-C₁₂alkyl and/or OH; the index i is a number from the range 1-12;
R′₇ is C₁-C₈alkylene;
R″₇ is C₁-C₄alkyl; or R″₇ together with R₁ is C₄-C₁ alkylene;
R₈ is C₁-C₁₈alkyl, C₃-C₁₂alkenyl, C₇-C₁₅phenylalkyl,
C₈-C₁₅phenylalkenyl, C₇-C₁₅phenylalkyl substituted in the phenyl moiety by C₁-C₄alkyl or C₁-C₄alkoxy, or is phenyl or phenyl substituted by C₁-C₄alkyl or C₁-C₄alkoxy;
R₉ is C₁-C₁₂alkyl or C₅-C₁₂cycloalkyl;
R′₉ is hydrogen, C₁-C₁₂alkyl or C₅-C₁₂cycloalkyl;
R₁₈ and R₁₉, independently of one another, are C₁-C₈alkyl;
R₂₀ is C₃-C₁₈alkenyl, C₇-C₁₈cycloalkenylalkyl or C₇-C₁₈bicycloalkenylalkyl;
R₁₇ and R₂₁ are hydrogen, or R₁₇ together with R₂₁ is a chemical bond;
R₂₂ is C₂-C₁₆alkylene, phenylene, phenylene- or cyclohexylene-interrupted C₂-C₁₀alkylene, or alkylene-phenylene of a total of 2-16 carbon atoms;
X is —NH—, —NR₉— or —O—;
or the compound 1-(but-3-enyl)-2,2,6,6-tetramethylpiperidine.

11. A compound of the formula V according to claim 10, of the formula Va 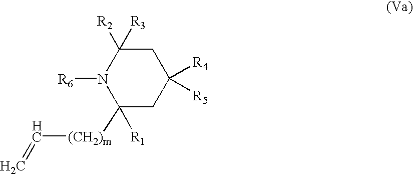
in which m is a number from the range 1-8;
R₁ is methyl or ethyl;
R₂ and R₃ are as defined for R₁ or together are C₄-C₁₁alkylene;
R₄ is hydrogen and
R₅ is hydrogen or a radical of the formula —X—(CO)ᵢ—R₈; the index i being 0 or 1;
or R₄ and R₅ together are ═O;
R₆ is hydrogen or C₁-C₁₈alkyl;
R₈ is C₁-C₁₈alkyl, C₇-C₁₅phenylalkyl, C₇-C₁₅phenylalkyl substituted in the phenyl moiety by C₁-C₄alkyl or C₁-C₄alkoxy, or is phenyl or C₁-C₄alkyl- or C₁-C₄alkoxy-substituted phenyl;
R₉ is C₁-C₁₂alkyl or C₅-C₁₂cycloalkyl; and
X is —NH—, —NR₉— or —O—.

12. A composition comprising
A) an organic material sensitive to oxidative, thermal and/or actinic degradation and
B) as stabilizer, a polymer or copolymer according to claim 9 and/or a compound according to claim 10.

13. A composition according to claim 12, wherein the organic material is a synthetic organic polymer.

14. A composition according to claim 12, comprising the stabilizer (component B) in an amount of from 0.01 to 50% based on the weight of component A.

15. A composition according to claim 12, comprising as additional component C an additive selected from the group consisting of antioxidants, UV absorbers, metal deactivators, phosphites, phosphonites, hydroxylamines, nitrones, thiosynergists, peroxide scavengers, polyamide stabilisers, basic co-stabilisers, nucleating agents, fillers, reinforcing agents, benzofuranones, indolinones, plasticisers, lubricants, emulsifiers, pigments, rheology additives, catalysts, flow-control agents, optical brighteners, flameproofing agents, antistatic agents and blowing agents.

16. A method of stabilizing organic material against thermal, oxidative and/or actinic degradation or build-up, which comprises adding to said material a polymer or copolymer according to claim 7 and/or a compound according to claim 8.

17. A method according to claim 16 wherein the organic material is a thermoplastic polymer to which a compound of the formula V, VI, VII and/or VII is admixed and the mixture obtained is heated.
